(19) United States
(12) Patent Application Publication
(10) Pub. No.: US 2026/0129349 A1
(43) Pub. Date: May 7, 2026

(54) SPEAKER ASSEMBLIES AND EARPHONES

(71) Applicant: SHENZHEN SHOKZ CO., LTD., Shenzhen (CN)

(72) Inventors: Yueqiang WANG, Shenzhen (CN); Junjiang FU, Shenzhen (CN); Song YOU, Shenzhen (CN); Yingying ZHANG, Shenzhen (CN)

(73) Assignee: SHENZHEN SHOKZ CO., LTD., Shenzhen (CN)

(21) Appl. No.: 19/435,833

(22) Filed: Dec. 30, 2025

Related U.S. Application Data
(63) Continuation of application No. PCT/CN2024/076067, filed on Feb. 5, 2024.

(51) Int. Cl. H04R 1/10; H04R 1/06; H04R 9/02; H04R 9/06

(52) U.S. Cl. CPC H04R 1/1075; H04R 1/06; H04R 1/1008; H04R 9/025; H04R 9/06; H04R 1/105; H04R 2460/13

(57) ABSTRACT

A speaker assembly is provided. The speaker assembly includes a housing assembly including a main housing, an air conduction speaker disposed within the main housing, and a bone conduction speaker rotatably supported on the main housing and being capable of rotating relative to the main housing along a preset rotation axis. A vibration direction of the air conduction speaker is parallel to the preset rotation axis, and a vibration direction of the bone conduction speaker is perpendicular to the preset rotation axis.

### CROSS-REFERENCE TO RELATED APPLICATIONS

This application is a Continuation of International Patent Application No. PCT/CN2024/076067, filed on Feb. 5, 2024, the entire contents of which are incorporated herein by reference.

### TECHNICAL FIELD

The present disclosure relates to the technical field of sound generation device, and in particular to a speaker assembly and an earphone.

### BACKGROUND

With a continuous popularization of electronic devices, the electronic devices have become indispensable social and entertainment tools in people's daily life. The electronic devices such as earphones and smart glasses have also been widely used in people's daily life, which are used in conjunction with cell phones, computers, and other terminal devices in order to facilitate the provision of an auditory feast for the user. Thus, how to improve a sound quality and a wearing comfort of the earphone and other electronic devices is an urgent problem at present.

### SUMMARY

The present disclosure provides a speaker assembly comprising a housing assembly and a bone conduction speaker. The bone conduction speaker includes a core shell, a transducer, a vibration transmission face-fitting assembly, and an auxiliary face-fitting assembly. The housing assembly includes a main housing, the core shell is supported on the main housing, and the transducer is disposed inside the core shell. The vibration transmission face-fitting assembly includes a vibration plate connected to the transducer and contacts a face region on a front side of a tragus of a user when the speaker assembly is in a wearing state. The auxiliary face-fitting assembly includes a rigid support member and a soft fitting member, the rigid support member is connected to the core shell, and when viewed in a vibration direction of the vibration plate, the rigid support member is closed and surrounds a periphery of the vibration plate along a circumference of the vibration plate, and a width of the rigid support member on a side facing the tragus is smaller than a width of the rigid support member on a side away from the tragus. The soft fitting member is disposed on the rigid support member, the soft fitting member is provided with a notch on a side facing the tragus and partially surrounds the vibration plate along the circumference of the vibration plate, and the soft fitting member is configured to contact the face region at the periphery of the vibration plate when the speaker assembly is in the wearing state.

In some embodiments, a ratio of the width of the rigid support member on the side facing the tragus to the width of the rigid support member on the side away from the tragus is less than or equal to 0.2.

In some embodiments, the rigid support member is detachably connected to the core shell.

In some embodiments, the rigid support member includes a support plate and an annular flange, the support plate is provided with a through hole, and the vibration plate is exposed through the through hole. The annular flange is disposed on a side of the support plate facing the core shell and surrounds a periphery of the through hole, and the annular flange is sleeved on a periphery of the core shell. An outer wall surface of the core shell and an inner wall surface of the annular flange are respectively provided with snap structures that cooperate with each other.

In some embodiments, the bone conduction speaker further includes a first vibration transmission sheet, and the transducer is elastically suspended in the core shell through the first vibration transmission sheet. The vibration plate is independent from the core shell, the vibration transmission face-fitting assembly further includes a soft vibration transmission member fitted to a side of the vibration plate facing the face region, and a hardness of the soft vibration transmission member is greater than a hardness of the soft fitting member. When the speaker assembly is in a free state, a side of the soft fitting member facing the face region protrudes from a side of the soft vibration transmission member facing the face region.

In some embodiments, the speaker assembly further includes an air conduction speaker disposed within the housing assembly. The air conduction speaker is provided with a first sound outlet, the housing assembly is provided with a second sound outlet corresponding to the first sound outlet, and when viewed in the vibration direction of the vibration plate, the second sound outlet is disposed between the vibration plate and the tragus and is at least partially disposed at a periphery of the rigid support member.

In some embodiments, the housing assembly further includes a main cover body, the main housing is configured to form an accommodation space with an open end, the main cover body is covered on the open end of the main housing, the air conduction speaker is disposed within the accommodation space, the second sound outlet is disposed on the main cover body, and the main cover body is provided with an opening through which the core shell and the vibration plate are exposed.

The present disclosure provides a speaker assembly. The speaker assembly includes a housing assembly, an air conduction speaker, and a bone conduction speaker. The bone conduction speaker is disposed eccentrically relative to the housing assembly, the bone conduction speaker includes a vibration transmission face-fitting assembly contacting a face region at a front of a tragus of a user when the speaker assembly is in a wearing state, and the vibration transmission face-fitting assembly is configured to transmit bone conduction sound waves. The air conduction speaker is disposed within the housing assembly, the air conduction speaker is provided with a first sound outlet, the housing assembly is provided with a second sound outlet corresponding to the first sound outlet, and the second sound outlet is located at a periphery of the vibration transmission face-fitting assembly when viewed in a vibration direction of the bone conduction speaker and is configured to transmit air conduction sound waves.

In some embodiments, the housing assembly further includes a main cover body and a main housing, the main housing includes a bottom wall and a circumferential sidewall connected to the bottom wall to form an accommodation space with an open end, the main cover body is covered on the open end of the main housing, the air conduction speaker is disposed within the accommodation space, the second sound outlet is disposed on the main cover body, the main cover body is provided with an opening, the bone conduction speaker includes a core shell and a vibration plate, the core shell and the vibration plate are exposed through the opening, and the second sound outlet is disposed toward an ear of the user when the speaker assembly is in the wearing state.

The present disclosure provides a speaker assembly. The speaker assembly includes a housing assembly and a bone conduction speaker. The housing assembly includes a main housing, the main housing includes a bottom wall and a circumferential sidewall connected to the bottom wall to form an accommodation space with an open end, the circumferential sidewall includes a first sidewall and a second sidewall disposed opposite to each other. The main housing further includes a partition assembly disposed between the first sidewall and the second sidewall and at least partially spaced apart from the first sidewall and the second sidewall, respectively, the partition assembly and the second sidewall are provided with a first shaft mechanism and a second shaft mechanism, respectively. The bone conduction speaker includes a core shell disposed between the partition assembly and the second sidewall, wherein a third shaft mechanism and a fourth shaft mechanism are respectively disposed on opposite sides of the core shell, the first shaft mechanism rotatably cooperates with the third shaft mechanism, and the second shaft mechanism rotatably cooperates with the fourth shaft mechanism, thereby rotatably supporting the core shell on the main housing.

In some embodiments, the partition assembly is configured to elastically deform in a spacing direction between the first sidewall and the second sidewall when the core shell is assembled to the main housing, and an elastic deformation capacity of the partition assembly along the spacing direction between the first sidewall and the second sidewall is greater than an elastic deformation capacity of the first sidewall and the second sidewall along the spacing direction between the first sidewall and the second sidewall.

In some embodiments, the speaker assembly further includes an air conduction speaker disposed between the partition assembly and the first sidewall.

In some embodiments, the circumferential sidewall further includes a third sidewall and a fourth sidewall disposed opposite to each other and connected between the first sidewall and the second sidewall, the partition assembly includes a partition body connected between the third sidewall and the fourth sidewall to divide the accommodation space into a first sub-space between the partition body and the first sidewall and a second sub-space between the partition body and the second sidewall, the air conduction speaker is disposed within the first sub-space and a vibration direction of the air conduction speaker is toward or away from the first sidewall, a vibration direction of the bone conduction speaker is toward or away from the bottom wall, and a projection of the bone conduction speaker along the vibration direction of the bone conduction speaker falls into the second sub-space.

In some embodiments, the partition assembly further includes an elastic arm connected to a side of the partition body away from the bottom wall, a size of the elastic arm along a spacing direction between the third sidewall and the fourth sidewall is smaller than a size of the partition body along the spacing direction between the third sidewall and the fourth sidewall, and the first shaft mechanism is disposed on the elastic arm.

In some embodiments, the main housing and the partition assembly are integrally molded, the first shaft mechanism is a rotating shaft, and the third shaft mechanism is a rotating slot that receives the rotating shaft.

In some embodiments, the elastic arm further elastically abuts a side of the air conduction speaker away from the first sidewall.

The present disclosure provides a speaker assembly. The speaker assembly includes a housing assembly, an air conduction speaker, and a bone conduction speaker. The housing assembly includes a main housing. The air conduction speaker is disposed within the main housing. The bone conduction speaker is rotatably supported on the main housing and is capable of rotating relative to the main housing along a preset rotation axis. A vibration direction of the air conduction speaker is parallel to the preset rotation axis, and a vibration direction of the bone conduction speaker is perpendicular to the preset rotation axis.

In some embodiments, the main housing includes a first bottom wall and a first circumferential sidewall connected to the first bottom wall to form a first accommodation space with an open end, the air conduction speaker and the bone conduction speaker are disposed within the first accommodation space from the open end of the main housing, a vibration direction of the air conduction speaker is toward or away from the first circumferential sidewall, and a vibration direction of the bone conduction speaker is toward or away from the first bottom wall.

In some embodiments, each of the main housing and the core shell is provided with a shaft mechanism that is mounted in a detachable manner, and the core shell is rotatably supported on the main housing through the shaft mechanisms of the main housing and the core shell.

The present disclosure provides a speaker assembly. The speaker assembly includes a bone conduction speaker, and the bone conduction speaker includes a core shell configured to form an accommodation space with an open end, a transducer disposed within the accommodation space, and a vibration transmission face-fitting assembly including a vibration plate, a soft vibration transmission member, and a rigid bracket. A middle region of the soft vibration transmission member is fixed to the vibration plate in a molding manner, an edge region of the soft vibration transmission member is fixed to the rigid bracket, the vibration plate is assembled and fixed to the transducer, the rigid bracket is assembled and fixed to the core shell, and the soft vibration transmission member covers the open end of the core shell and is configured to contact a skin of the user.

In some embodiments, a plurality of embedded slots are disposed on a side of the vibration plate facing the soft vibration transmission member, and the soft vibration transmission member is embedded into the plurality of embedded slots in a molding manner.

In some embodiments, when viewed in a vibration direction of the vibration plate, the plurality of embedded slots are disposed near an edge of the vibration plate and are spaced apart around a central axis of the vibration plate.

In some implementations, the rigid bracket has an annular shape, an axial direction of the rigid bracket is aligned with a vibration direction of the vibration plate, and the rigid bracket is inserted along the axial direction and sleeved on the core shell.

In some embodiments, an annular groove is disposed on an end surface of the open end of the core shell to form an inner shell and an outer shell separated by the annular groove and nested with each other at the end portion of the core shell, and the rigid bracket is embedded in the annular groove and sleeved on a periphery of the inner shell.

In some embodiments, the transducer includes a magnetic circuit system elastically suspended within the core shell, and the rigid bracket is a non-magnetic metal support.

The present disclosure provides an earphone including the speaker assembly and a wearing assembly connected to the speaker assembly of any of the above embodiments. The wearing assembly is configured to position the speaker assembly in a face region on a front side of a tragus of a user when the earphone is in a wearing state.

The beneficial effects of the present disclosure include that: through the above ways, the auxiliary face-fitting assembly plays a role of auxiliary support. In the wearing state, the auxiliary face-fitting assembly contacts the face region on the front side of the user's tragus to play the role of auxiliary support for the bone conduction speaker along the bone conduction vibration direction. This effectively alleviates a support pressure of the vibration plate on the face along the vibration direction, thereby effectively reducing the work load of the transducer, so as to effectively enhance the sound quality of the bone conduction speaker, and ultimately effectively enhance the sound quality of the earphone. Further, when viewed along the direction of the bone conduction vibration, the auxiliary face-fitting assembly surrounds the periphery of the vibration plate along the circumferential direction of the vibration plate, ensuring that the periphery of the vibration plate can be assisted and supported by the auxiliary face-fitting assembly. This significantly enhances the positioning effect of the auxiliary face-fitting assembly on the vibration plate. Further, when viewed along the vibration direction of the vibration plate, a width of a side of the auxiliary face-fitting assembly facing the tragus (the width of the side of the auxiliary face-fitting assembly facing the tragus is equal to the width of the side of the rigid support member facing the tragus as described above) is smaller than a width of the side of the auxiliary face-fitting assembly away from the tragus (the width of the side of the auxiliary face-fitting assembly away from the tragus is equal to the width of the side of the rigid support member away from the tragus as described above). In this way, the vibration plate as a whole can be closer to the tragus of the user, thereby effectively enhancing the sound transmission effect of the bone conduction speaker to effectively enhance the sound quality of the bone conduction speaker, and thereby effectively enhance the sound quality of the earphone. Furthermore, the auxiliary face-fitting assembly includes the rigid support member for rigid support, and also includes the soft fitting member for a flexible contact with the user's face. In the wearing state, the auxiliary face-fitting assembly provides the rigid support through the rigid bracket while softly contacting the face region on the front side of the user's tragus, which can effectively ensure the support capability of the auxiliary face-fitting assembly while also effectively improving the softness of the auxiliary face-fitting assembly, thereby effectively improving the wearing comfort of the earphone. The rigid support member encloses and surrounds the periphery of the vibration plate along the circumferential direction of the vibration plate, so that the auxiliary face-fitting assembly is arranged around the periphery of the vibration plate as a whole. Thus, the periphery of the vibration plate can all be supported by the auxiliary face-fitting assembly, thereby effectively enhancing the positioning effect of the auxiliary face-fitting assembly on the vibration plate. The width of the side of the rigid support member facing the tragus is less than the width of the side of the rigid support member away from the tragus, so that as a whole, the width of the side of the auxiliary face-fitting assembly towards the tragus is less than the width of the side of auxiliary face-fitting assembly away from the tragus, so that the vibration plate can be closer to the user's tragus, so as to effectively improve the sound transmission effect of the bone conduction speaker, and thereby effectively improving the sound quality of the earphone. Furthermore, the soft fitting member is provided with the notch on the side facing the tragus. On the one hand, it ensures that the side of the soft fitting member with the notch does not affect the position of the vibration plate. Due to the existence of the notch, the vibration plate can be closer to the user's tragus and the ear canal, thereby improving the vibration transmission efficiency. On the other hand, as the width of the side of the rigid support member close to the tragus is relatively small, the support effect of the rigid support member on the soft fitting member in this region is relatively small, and therefore providing the notch on the side of the soft fitting member facing the tragus effectively prevents a portion of the soft fitting member on the side facing the tragus from being deformed or damaged, thus avoiding impact on the use of the earphone.

It should be appreciated that the above general description and the detailed descriptions that follow are merely exemplary and explanatory, and are not intended to limit the present disclosure.

### BRIEF DESCRIPTION OF THE DRAWINGS

To more clearly illustrate the technical solutions in the embodiments of the present disclosure, the following will briefly introduce the accompanying drawings that need to be used in the description of the embodiments. It is obvious that the following drawings are only some of the embodiments of the present disclosure, and for those skilled in the art, other drawings may be obtained according to these drawings without creative labor.

FIG. 1 is a schematic diagram illustrating a three-dimensional (3D) structure of an earphone according to an embodiment of the present disclosure;

FIG. 2 is a schematic diagram illustrating an exploded structure of the earphone illustrated in FIG. 1;

FIG. 3 is a schematic diagram illustrating an earphone in a wearing state according to some embodiments of the present disclosure;

FIG. 4 is a schematic diagram illustrating a 3D structure of a speaker assembly illustrated in FIG. 1 in a front direction;

FIG. 5 is a schematic diagram illustrating a 3D structure of the speaker assembly illustrated in FIG. 1 in a back direction;

FIG. 6 is a schematic diagram illustrating an exploded structure of the speaker assembly illustrated in FIG. 1;

FIG. 7 is a schematic diagram illustrating a cross-section of the speaker assembly illustrated in FIG. 5 in an A direction;

FIG. 8 is a schematic diagram illustrating an exploded structure of a bone conduction speaker of the speaker assembly illustrated in FIG. 6;

FIG. 9 is a schematic diagram illustrating a forward structure of a rigid support member illustrated in FIG. 8;

FIG. 10 is a schematic diagram illustrating a 3D structure of the rigid support member illustrated in FIG. 8;

FIG. 11 is a schematic diagram illustrating a cross-sectional structure of a bone conduction speaker in the speaker assembly illustrated in FIG. 6;

FIG. 12 is a schematic diagram illustrating a 3D structure of a vibration plate illustrated in FIG. 8;

FIG. 13 is a schematic diagram illustrating a longitudinal cross-section of a rigid support illustrated in FIG. 8;

FIG. 14 is a schematic diagram illustrating a 3D structure of a core shell illustrated in FIG. 8 in a front direction;

FIG. 15 is a schematic diagram illustrating a 3D structure of a main housing illustrated in FIG. 6.

FIG. 16 is a schematic diagram illustrating a front structure of the main housing illustrated in FIG. 6;

FIG. 17 is a schematic diagram illustrating a 3D structure of an air conduction speaker illustrated in FIG. 6;

FIG. 18 is a schematic diagram illustrating a 3D structure of a core shell illustrated in FIG. 8 in a bottom direction;

FIG. 19 is a schematic diagram illustrating a structure of a speaker assembly according to an embodiment of the present disclosure;

FIG. 20 is a schematic diagram illustrating a structure of a speaker assembly according to another embodiment of the present disclosure;

FIG. 21 is a schematic diagram illustrating a structure of a core shell of the present disclosure;

FIG. 22 is a schematic diagram illustrating a structure of the core shell illustrated in FIG. 21 at another perspective;

FIG. 23 is a schematic diagram illustrating a structure of the core shell illustrated in FIG. 21 at another perspective; and

FIG. 24 is a schematic diagram illustrating a structure of a speaker assembly according to another embodiment of the present disclosure.

### DETAILED DESCRIPTION

To enable those skilled in the art to better understand the technical solutions of the present disclosure, a charging box provided herein is described in further detail below in conjunction with the accompanying drawings and specific embodiments. It is to be understood that the described embodiments are only a part of the embodiments of the present disclosure, and not all of them. Based on the embodiments in the present disclosure, all other embodiments obtained by those skilled in the art without creative labor fall within the scope of protection of the present disclosure.

The terms “first,” “second,” etc. in the present disclosure are used to distinguish between different objects and are not used to describe a particular order. Additionally, the terms “comprising” and “having,” and any variations thereof, are intended to cover non-exclusive objects. For example, a process, method, system, product, or device that includes a series of operations or units is not limited to the listed operations or units, but optionally also includes operations or units that are not listed, or optionally also includes other operations or units inherent to those processes, methods, products, or devices.

The following embodiments of the present disclosure describe an exemplary structure of earphone 1.

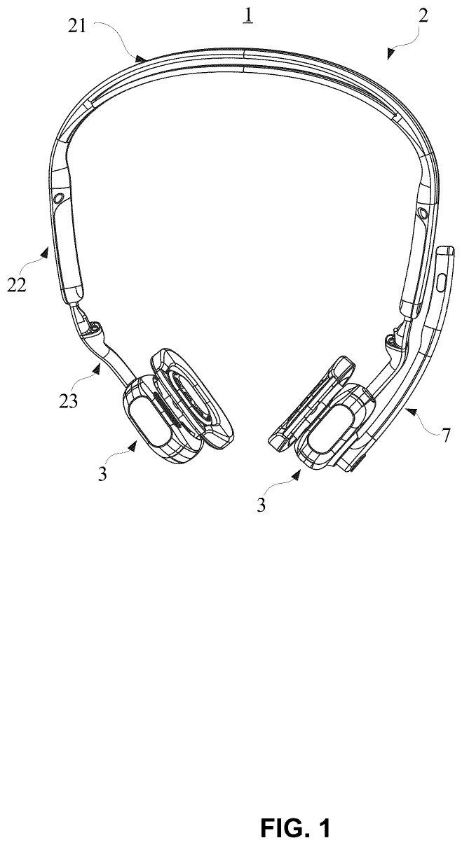

As shown in FIG. 1, the earphone 1 includes a wearing assembly 2, a speaker assembly 3, and a stick microphone assembly 7. There may be two speaker assemblies 3. The two speaker assemblies 3 are configured to transmit vibration and/or sound to left and right ears of a user, respectively. The two speaker assemblies 3 may be the same or different. For example, one speaker assembly 3 is disposed with the stick microphone assembly 7, and the other speaker assembly 3 is not disposed with the stick microphone assembly 7.

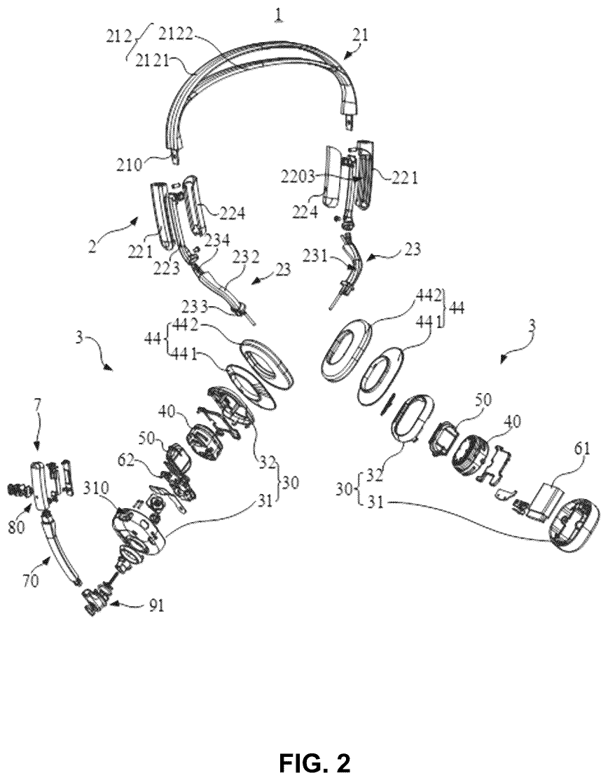

As shown in FIG. 2, the wearing assembly 2 may include a headband assembly 21, a telescopic assembly 22, and a torsion assembly 23. There may be two telescopic assemblies 22, and there may be two torsion assemblies 23. Two ends of the headband assembly 22 are connected to the two telescopic assemblies 21 in a one-to-one correspondence 1, and the two telescopic assemblies 22 are connected to the two torsion assemblies 23 in a one-to-one correspondence. The two torsion assemblies 23 are connected in a one-to-one correspondence to the two speaker assemblies 3. The headband assembly 21 is used to wrap around a top of a head of a user, and a shape of the headband assembly 21 may be matched to a contour of the head of the user, which makes it more comfortable and stable when the user wears the headband assembly 21. The headband assembly 21 is also used to elastically clamp two sides of the head of the user. The telescopic assembly 22 can perform telescopic movement to change its length, and thus change a distance between the headband assembly 21 and the speaker assembly 3, and thus is adaptable according to different head shapes of the user to be able to place the speaker assembly 3 in a suitable position, thereby improving a compatibility of the wearing assembly 2. The torsion assembly 23 may generate an elastic torsion, which can generate torsion when the speaker assembly 3 contacts the head of the user in the wearing state, so that the speaker assembly 3 can better fit a user's face or be positioned on the ear.

As shown in FIG. 2, the headband assembly 21 may include a clamping assembly 210 and a first elastic cover body 212. The clamping assembly 210 may include an elastic sheet that realizes an elastic clamping function. The first elastic cover body 212 may include a covering main body 2121 and an elastic band 2122 integrally molded with the covering main body 2121. The covering main body 2121 is molded to cover around a periphery of the clamping assembly 210 and a wire. Two ends of the elastic band 2122 are spaced apart from each other along a length direction of the clamping assembly 210 and are respectively connected to the covering main body 2121. Between the connecting positions of the two ends of the elastic band 2122 and the covering main body 2121, the elastic band 2122 and the wrapping body 2121 are separated from each other, and the elastic band 2122 is configured to assist in positioning the clamping assembly 210 onto the head of the user in the wearing state.

As shown in FIG. 2, the telescopic assembly 22 may include a fixing portion 221 and a telescopic portion 223 telescopically disposed relative to the fixing portion 221, and the two ends of the clamping assembly 210 are respectively fixed with the corresponding fixing portion 221, e.g., in a plug-in fixation. The telescopic assembly 22 may include a decorative portion 224, the fixing portion 221 is disposed with a slide groove 2203, the telescopic portion 223 is slidably provided within the slide groove 2203, and the decorative portion 224 is assembled and fixed (e.g., capped to each other) with the fixing portion 221 to cover the slide groove 2203 and a portion of the telescopic portion 223 disposed within the slide groove 2203.

As shown in FIG. 2, the torsion assembly 23 may include an elastic connecting member 231, a second elastic cover body 232, and a first connector portion 233 and a second joint portion 234 disposed at two ends of the elastic connecting member 231. The elastic connecting member 231 is shown generally in dashed lines in FIG. 2. The second elastic cover body 232 is molded to cover a periphery of the elastic connecting member 231, and a wire is threaded within the second elastic cover body 232. The first connector portion 233 is plugged into a connector hole 310 of the speaker assembly 3, and the second connector portion 234 is plugged into a connector hole (not marked) of the telescopic portion 223.

As shown in FIG. 2, the speaker assembly 3 may include a housing assembly 30, a bone conduction speaker 40, and an air conduction speaker 50. The speaker assembly 3 may also include at least one of a battery 61 and a control circuit board 62. The housing assembly 30 is configured to accommodate the bone conduction speaker 40 and the air conduction speaker 50. The bone conduction speaker 40 is configured to fit on a user's face and the air conduction speaker 50 is configured to deliver air conduction sound waves to a user's ear canal. When the earphone 1 is worn on a user's head, the wearing assembly 2 may place the speaker assembly 3 in a face region on a front side of a user's tragus.

As shown in FIG. 2, the housing assembly 30 may include a main housing 31 and a main cover body 32. The main housing 31 may have an open end, and the main cover body 32 covers the open end of the main housing 31. The main cover body 32 may include a sound outlet (not marked) for the air conduction speaker 50 to emit sound. A portion of the bone conduction speaker 40 may be exposed through the open end of the main housing 31 to fit the user's face. Vibration directions of the bone conduction speaker 40 and the air conduction speaker 50 may be perpendicular to each other, and the bone conduction speaker 40 and the air conduction speaker 50 are assembled on the main housing 31 with their vibration directions perpendicular to each other to minimize a mutual interference between the bone conduction speaker 40 and the air conduction speaker 50. The bone conduction speaker 40 may be disposed with an auxiliary face-fitting assembly 44 for face-fitting comfort. The auxiliary face-fitting assembly 44 is configured to increase the contact area between the bone conduction speaker 40 and the user's face in the wearing state, thereby improving a wearing comfort. The auxiliary face-fitting assembly 44 may include a rigid support member 441 and a soft fitting member 442. The rigid support member 441 is configured to support the soft fitting member 442 to improve a structural strength and a stability of the auxiliary face-fitting assembly 44. The soft fitting member 442 is configured to fit the user's face towards the user's face, which can fit the user's face more stably and tightly under the support of the rigid support member 441.

As shown in FIG. 2, the speaker assembly 3 may include at least one of the control circuit board 62 and the battery 61. For example, one speaker assembly 3 includes the control circuit board 62, and the other speaker assembly 3 does not include the control circuit board 62, but includes the battery 61. A connection wire between the two speaker assemblies 3 may be threaded across the wearing assembly 2. For example, the one speaker assembly 3 includes both the control circuit board 62 and the battery 61. Or there are two control circuit boards 62, and each speaker assembly 3 includes one control circuit board 62. There may be two batteries 61, and each speaker assembly 3 may include one battery 61 respectively.

The stick microphone assembly 7 is disposed in a rotatable manner on the speaker assembly 3. The stick microphone assembly 7 may include a stick body assembly 70, a microphone assembly 80, and a shaft mechanism 91. The microphone assembly 80 and the shaft mechanism 91 may be connected to both ends of the stick body assembly 70, and the shaft mechanism 91 is rotatably connected to the speaker assembly 3. In the wearing state, the shaft mechanism 91 may place the microphone assembly 80 in a pickup region of a user's mouth by rotating relative to the speaker assembly 3. The microphone assembly 80 is disposed with at least one microphone and associated keys, and the keys enable the microphone to be turned on or off.

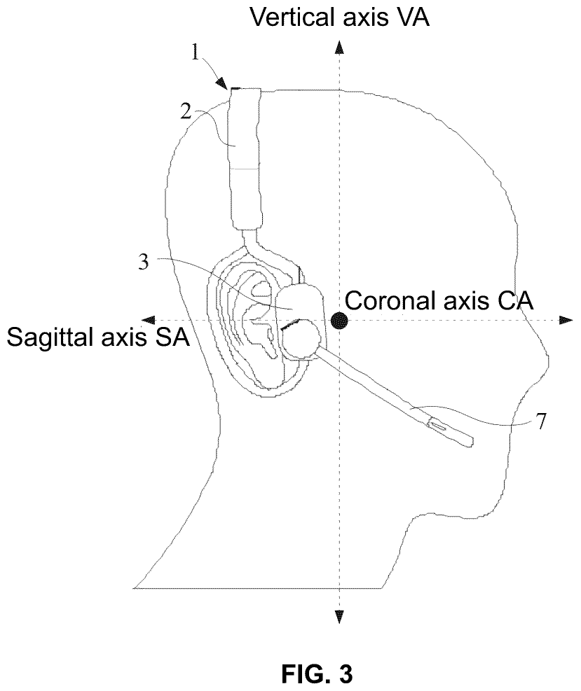

In the fields of medicine and anatomy, three basic sections of the human body, namely a sagittal plane, a coronal plane, and a horizontal plane, as well as three basic axes of the human body, namely a sagittal axis, a coronal axis, and a vertical axis, may be defined. The sagittal plane refers to a section along an anterior-posterior direction of the body and perpendicular to the ground, which divides the body into left and right portions; the coronal plane refers to a section along a left-right direction of the body and perpendicular to the ground, which divides the body into front and back portions; and the horizontal plane refers to a section along an up-down direction of the body and parallel to the ground, which divides the human body into upper and lower portions. Correspondingly, the sagittal axis SA refers to an axis along the anterior-posterior direction of the body and perpendicular to the coronal plane, the coronal axis refers to an axis along the left-right direction of the body and perpendicular to the sagittal plane, and the vertical axis VA refers to an axis along the upper-lower direction of the body and perpendicular to the horizontal plane. As shown in FIG. 3, when the earphone 1 is in the wearing state, the wearing assembly 2 is clamped on two sides of the user's head, and the speaker assembly 3 is located in a face region in front of the tragus along the sagittal axis SA.

The following contents will describe the earphone 1 or some of the above-mentioned components, structures, etc. in detail. Of course, some of the above-mentioned structures, components, such as the bone conduction speaker 40, the air conduction speaker 50, etc., may be used not only on the earphone 1, but also on other electronic devices, such as cell phones, speakers, smart wearable devices, etc.

The following mainly describes, for example, a structure of the speaker assembly 3 of the earphone 1.

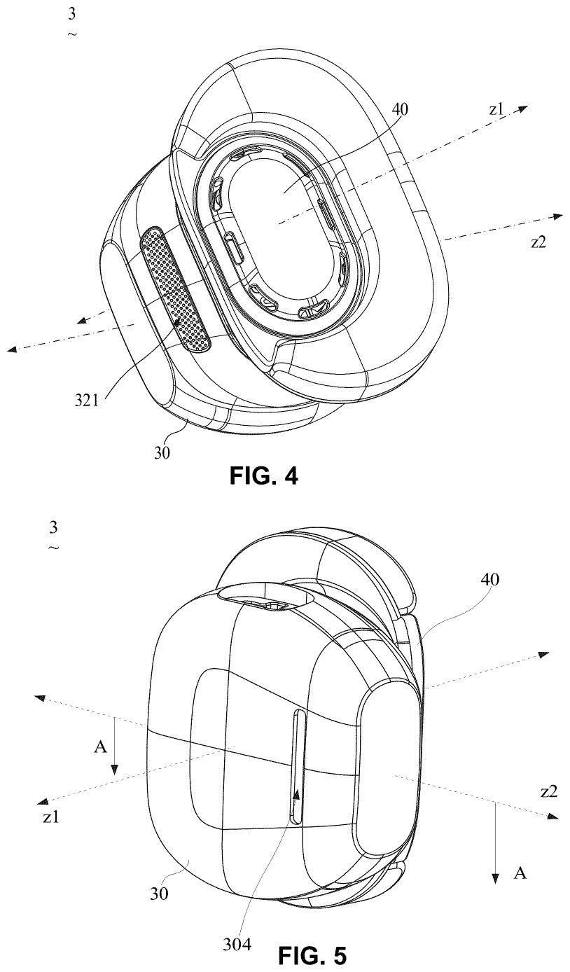

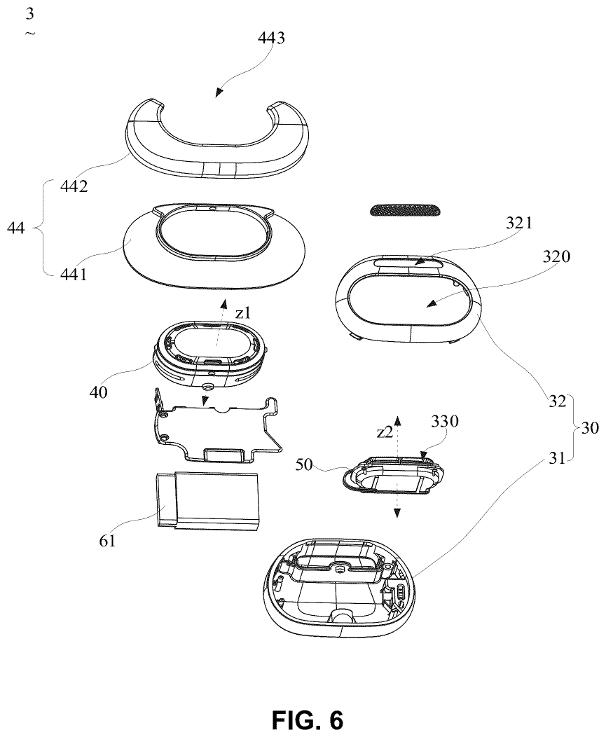

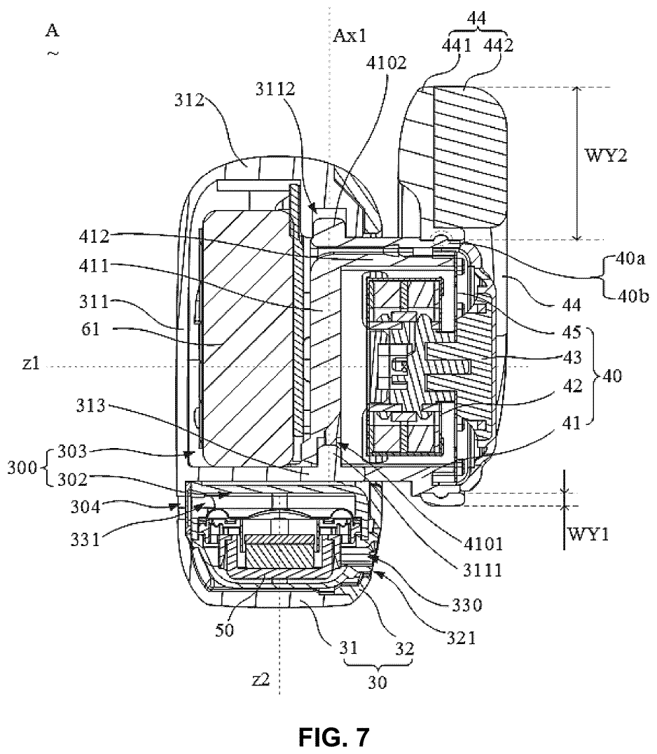

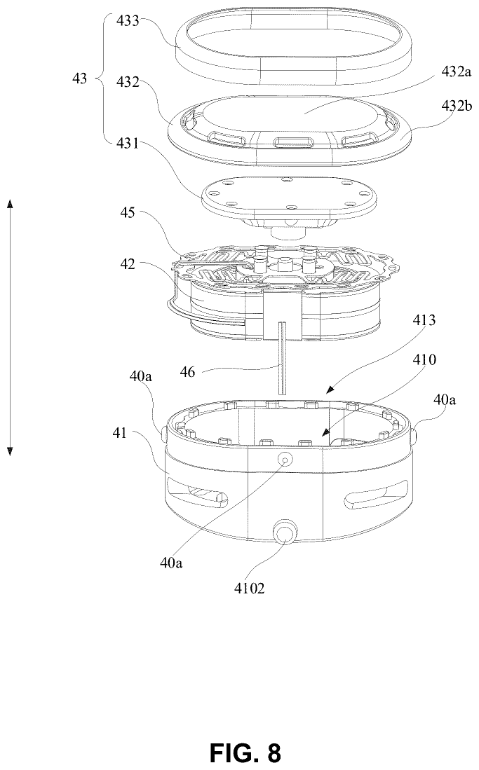

Optionally, as shown in FIG. 2, FIG. 4, and FIG. 5, in some embodiments, the speaker assembly 3 includes the housing assembly 30 and the bone conduction speaker 40. Further referring to FIG. 6, FIG. 7, and FIG. 8, the bone conduction speaker 40 includes a core shell 41, a transducer 42, a vibration transmission face-fitting assembly 43, and the auxiliary face-fitting assembly 44. The housing assembly 30 includes a main housing 31, the core shell 41 is supported on the main housing 31, and the transducer 42 is disposed inside the core shell 41. The vibration transmission face-fitting assembly 43 includes a vibration plate 431 connected to the transducer 42 and in direct or indirect contact with a face region on the front side of the tragus of the user in the wearing state. When the vibration plate 431 is in indirect contact with the face region, the auxiliary face-fitting assembly 44 includes the rigid support member 441 and the soft fitting member 442, and the rigid support member 441 is connected to the core shell 41. When viewed in a vibration direction of the vibration plate 431, the rigid support member 441 is closed and surrounds a periphery of the vibration plate 431 along a circumference of the vibration plate 431, and a width WY1 of a side of the rigid support member 441 facing the tragus is smaller than a width WY2 of a side away from the tragus. The soft fitting member 442 is disposed on the rigid support member 441, and the soft fitting member 442 is disposed with a notch 443 on a side facing the tragus and partially surrounds the vibration plate 431 along the circumference of the vibration plate 431. The soft fitting member 442 is configured to contact the face region at the periphery of the vibration plate 431 in the wearing state.

Specifically, the bone conduction speaker 40 conducts sound to the user through bone conduction. The transducer 42 is a device that converts an electrical signal into vibration, which is connected to the vibration plate 431 and drives the vibration plate 431 to vibrate based on a corresponding electrical signal. The vibration direction of the vibration plate 431 is also referred to as a bone conduction vibration direction z1, that is, the vibration direction of the bone conduction speaker 40. The bone conduction vibration direction z1 is approximately parallel to the coronal axis of the human body in the wearing state. The vibration plate 431, as a main component of the vibration transmission face-fitting assembly 43, is in direct or indirect contact with the face region on the front side of the user's tragus when the earphone 1 is in the wearing state. Driven by the transducer 42, the vibration plate 431 transmits sound to the user through bone conduction.

Further, the auxiliary face-fitting assembly 44 plays a role of auxiliary support, and in the state of wearing, the auxiliary face-fitting assembly 44 is in contact with the face region on the front side of the user's tragus, so as to support the bone conduction speaker 40 along the bone conduction vibration direction z1. In such cases, the support pressure of vibration plate 431 on the face along its vibration direction can be effectively relieved, which effectively reduces the workload of the transducer 42 to effectively improve the sound quality of the bone conduction speaker 40, thereby effectively improving a sound quality of the earphone 1. When viewed in the bone conduction vibration direction z1, the auxiliary face-fitting assembly 44 surrounds the periphery of the vibration plate 431 along the circumferential direction of the vibration plate 431, such that the periphery of the vibration plate 431 may all be supported by the auxiliary face-fitting assembly 44, which effectively improves a positioning effect of the auxiliary face-fitting assembly 44 on the vibration plate 431.

Further, when viewed in the vibration direction of the vibration plate 431, a width of the auxiliary face-fitting assembly 44 on a side facing the tragus (wherein the width of the auxiliary face-fitting assembly 44 on a side facing the tragus is equal to the width WY1 of the rigid support member 441 on the side facing the tragus as described above) is less than the width on the side away from the tragus (the width of the auxiliary face-fitting assembly 44 on the side away from the tragus is equal to the width WY2 of the rigid support member 441 away from the tragus). In such cases, the vibration plate 431 as a whole may be closer to the user's tragus, thereby effectively improving a sound transmission effect of the bone conduction speaker 40 to effectively improve the sound quality of the bone conduction speaker 40, thereby effectively improving the sound quality of the earphone 1.

Further, the auxiliary face-fitting assembly 44 includes the rigid support member 441 for rigid support, and further includes the soft fitting member 442 for flexible contact with the user's face. In the wearing state, the auxiliary face-fitting assembly 44 is in contact with the user's face region on the front side of the user's tragus through the soft fitting member, and provides hard support through the rigid support, which effectively ensures a support capability of the auxiliary face-fitting member 44 and further effectively improves softness of the auxiliary face-fitting assembly 44, thereby effectively improving the wearing comfort of the earphone 1. The rigid support member 441 is closed and surrounds the periphery of the vibration plate 431 along the circumference of the vibration plate 431, so as to make the auxiliary face-fitting assembly 44 as a whole surround the periphery of the vibration plate 431, thereby enabling the periphery of the vibration plate 431 to be supported by the auxiliary face-fitting assembly 44, and effectively improving the positioning effect of the auxiliary face-fitting assembly 44 on the vibration plate 431. Moreover, the width WY1 of the rigid support member 441 on the side facing the tragus is smaller than the width WY2 of the rigid support member 441 on the side away from the tragus, so that the width of the auxiliary face-fitting assembly 44 on the side facing the tragus is smaller than the width of the auxiliary face-fitting assembly 44 on the side away from the tragus. The vibration plate 431 may thus be closer to the user's tragus to effectively improve the sound transmission effect of the bone conduction speaker 40, thus effectively improving the sound quality of the earphone 1.

Further, the soft fitting member 442 is disposed with the notch 443 on a side facing the tragus such that, on the one hand, the side of the soft fitting member 442 where the notch 443 is provided does not affect the position of the vibration plate 431, and the vibration plate 431 may be closer to the user's tragus and closer to the ear canal due to the presence of the notch 443, so that a vibration transmission efficiency of the vibration plate 431 is higher; on the other hand, as the width of the rigid support member 441 on the side near the tragus is small, the support effect of the rigid support member 441 on the soft fitting member 442 in this region is small, so by providing the notch 443 on the side of the soft fitting member 442 facing the tragus, deformation or damage of the soft fitting member 442 on the side facing the tragus is effectively prevented, thereby improving the sound quality of the earphone 1.

Optionally, in some embodiments, a material of the soft fit member 442 may include a softer textured material such as a sponge, etc.

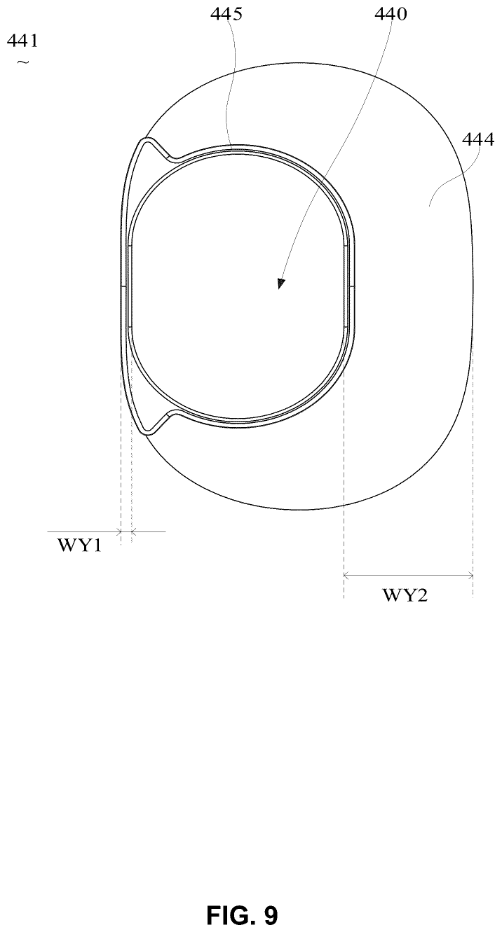

Optionally, as shown in FIG. 7 and FIG. 9, in some embodiments, a ratio of the width WY1 of the rigid support member 441 on the side facing the tragus to the width WY2 of the rigid support member 441 on the side away from the tragus is less than or equal to 0.2. If the ratio is too great, a distance between the vibration plate 431 and the tragus is increased, which affects the sound transmission effect of the bone conduction speaker 40, and if the ratio is too small, a structural strength of the auxiliary face-fitting assembly 44 may be reduced, thereby reducing an auxiliary support capability of the auxiliary face-fitting assembly 44. Therefore, by setting the above ratio at, for example, 0.1, 0.15, or 0.2, the auxiliary face-fitting assembly 44 may have a stable auxiliary support capability while ensuring that the vibration plate 431 is sufficiently close to the tragus to effectively improve the sound transmission effect of the bone conduction speaker 40, thereby effectively improving the sound quality of the bone conduction speaker 40.

Optionally, in some embodiments, the rigid support member 441 is made of plastic and the width WY1 of the rigid support member on the side facing the tragus is in a range of 0.5 mm-1.5 mm. Specifically, the rigid support member 441 is made of plastic, which effectively ensures the structural strength of the rigid support member 441 while effectively reducing a mass of the rigid support member 441, thereby effectively reducing the overall mass of the bone conduction speaker 40. Furthermore, if the width WY1 of the rigid support member 441 on the side facing the tragus is too great, the distance between the vibration plate 431 and the tragus may be increased, which affects the sound transmission effect of the bone conduction speaker 40, and if the width WY1 is too small, the structural strength of the auxiliary face-fitting assembly 44 may be reduced, thus reducing the auxiliary support ability of the auxiliary face-fitting assembly 44. Therefore, under the premise that the rigid support member 441 is made of the material mentioned above, the width WY1 may be set in a range of 0.1 mm-2 mm. In such cases, the vibration plate 431 may be set as close to the tragus as possible, and at the same time, the structural strength of the rigid support member 441 and a connection strength between the rigid support member 441 and the core shell 41 are ensured. In some embodiments, the rigid support member 441 is made of a material such as resin, carbon fiber, or metal, etc. For example, in some embodiments, the width WY1 is 0.7, 0.8, or 0.9 mm, and the width WY2 is set as 10.75 mm±0.1 mm. As another example, in some embodiments, the width WY1 is 0.84 m, and the width WY2 is 9.8 mm.

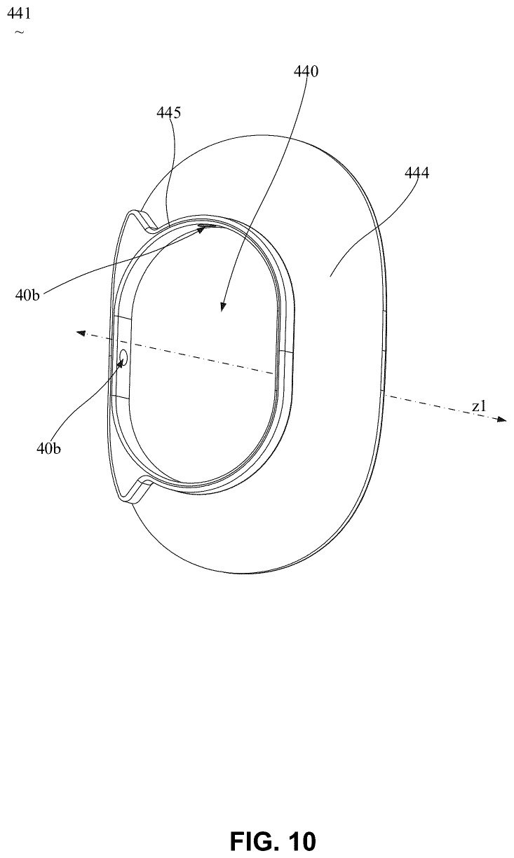

Optionally, as shown in FIG. 7 and FIG. 10, in some embodiments, the rigid support member 441 is detachably connected to the core shell 41. In this way, the rigid support member 441 as a perishable part may be removed from the core shell 41 for replacement when damaged, thereby not affecting the use of the earphone 1, and effectively improving the service life of the earphone 1.

Optionally, as shown in FIG. 7 and FIG. 10, in some embodiments, the rigid support member 441 includes a support plate 444 and an annular flange 445. The support plate 444 is provided with a through hole 440, and the vibration plate 431 is exposed through the through hole 440. The annular flange 445 is disposed on a side of the support plate 444 facing the core shell and surrounds a periphery of the through hole 440. The annular flange 445 is sleeved on a periphery of the core shell 41, and an outer wall surface of the core shell 41 and an inner wall surface of the annular flange 445 are respectively disposed with snap structures 40a, 40b that cooperate with each other. Specifically, the snap structure 40a is disposed on the outer wall surface of the core shell 41, and the snap structure 40b is disposed on the inner wall surface of the annular flange 445.

Specifically, a central axis of the through hole 440 is closer to the tragus than a central axis of the support plate 444, the width WY1 is smaller than the width WY2, so that the vibration plate 431 as a whole is closer to the user's tragus, thereby effectively improving the sound transmission effect of the bone conduction speaker 40 and the sound quality of the bone conduction speaker 40. Further, the annular flange 445 is disposed on a side of the support plate 444 facing the core shell 41 and surrounds the periphery of the through hole 440, so that based on the support plate 444, a height and a structural strength of the annular flange 445 increases, so as to facilitate the setting of the snap structure 40b. And through the annular flange 445 sleeved on the periphery of the core shell 41, the connection between the snap structure 40b and the snap structure 40a on the core shell 41 may be more stable and reliable. Further, the detachable connection through the snap structures may also effectively simplify an assembly operation of the rigid support member 441 and the core shell 41, thereby effectively improving the assembly efficiency of the rigid support member 441 and the core shell 41.

Optionally, in an embodiment, the rigid support member 441 is integrally formed. The side of the rigid support member 441 facing the core shell 41 surrounds the through hole 440 around the bone conduction vibration direction z1 and protrudes to form the annular flange 445. Optionally, in other embodiments, the rigid support member 441 is also formed in other manners. For example, the support plate 444 and the annular flange 445 are connected by welding, bonding, and other manners to form the above-mentioned rigid support member 441.

Optionally, as shown in FIGS. 7-8, in some embodiments, the bone conduction speaker 40 further includes a first vibration transmission sheet 45, the transducer 42 is elastically suspended in the core shell 41 through the first vibration transmission sheet 45, and the vibration plate 431 is independent of the core shell 41. The vibration transmission face-fitting assembly 43 further includes a soft vibration transmission member 432 fitted to the side of the vibration plate 431 facing the face region, the hardness of the soft vibration transmission member 432 is greater than the hardness of the soft fitting member 442, and in a free state, a side of the soft fitting member 442 facing the face region protrudes from a side of the soft vibration transmission member 432 facing the face region.

Specifically, the first vibration transmission sheet 45 is a member with a certain elasticity. The transducer 42 is elastically suspended in the core shell 41 through the first vibration transmission sheet 45, and the vibration plate 431 is independent of the core shell 41. In such cases, the first vibration transmission sheet 45 can well connect the transducer 42 and the vibration transmission face-fitting assembly 43 to the core shell 41, and can also effectively slow down the vibration of the transducer 42 transmitted to the core shell 41, thereby effectively improving the sound quality of the bone conduction speaker 40. The vibration transmission face-fitting assembly 43 further includes the soft vibration transmission member 432 fitted to the side of the vibration plate 431 facing the face region, the vibration plate 431 further drives the soft vibration transmission member 432 to vibrate under the driving of the transducer 42. The vibration plate 431 indirectly contacts the face region on the front side of the tragus through the soft vibration transmission assembly and transmits sound to the user through bone conduction. In other words, the soft vibration transmission assembly contacts the face region on the front side of the tragus and transmits the sound to the user through bone conduction. In this way, the comfort of the bone conduction speaker 40 may be effectively improved when transmitting the sound to the user through bone conduction.

Further, the soft vibration transmission member 432 and the soft fitting member 442 are used as members that come into contact with the user's face, and if the hardness of the soft vibration transmission member 432 is too great or greater than the hardness of the soft vibration transmission member 432, it may impede the soft vibration transmission member 432 from transmitting vibrations to the face region in front of the user's tragus. Therefore, the hardness of the soft vibration transmission member 432 is set to be greater than the hardness of the soft fitting member 442 to reduce the vibration transmission resistance of the soft fitting member 442 to the soft vibration transmission member 432, thus effectively improving the vibration transmission efficiency of the soft vibration transmission member 432. Further, the hardness of the soft fitting member 442 is smaller than the hardness of the soft vibration transmission member 432, so that the soft fitting member 442 is more prone to deformation compared to the soft vibration transmission member 432. In such cases, in the free state (when the earphone 1 is in a non-wearing state), by protruding the side of the soft fitting member 442 facing the face region towards the side of the soft vibration transmission member 432 facing the face region, a greater deformation space may be provided for the soft fitting member 442 along the bone conduction vibration direction z1. As the soft fitting member 442 is softer compared to the soft vibration transmission member 432, when the earphone 1 is in the wearing state, the greater deformation space ensures that the auxiliary face-fitting assembly 44 has a sufficiently great auxiliary support force while ensuring that the side of the soft fitting member 442 facing the face region and the side of the soft vibration transmission member 432 facing the face region can be flush with the face. In this way, the support pressure of the vibration plate 431 along the vibration direction is effectively relieved, and the working load of the transducer 42 is effectively reduced to effectively improve the sound quality of the bone conduction speaker 40.

Optionally, in some embodiments, in the free state, the side of the soft fitting member 442 facing the face region may be flush with the side of the soft vibration transmission member 432 facing the face region. In the bone conduction vibration direction z1, in the wearing state, the soft vibration transmission member 432 is provided with a preset distance that allows the soft vibration transmission member 432 to move relative to the soft fitting member 442 in the wearing state. By providing the soft vibration transmission member 432 with the preset distance, the soft fitting member 442 is provided with a greater deformation space in the bone conduction vibration direction z1, so that when the earphone 1 is in the wearing state, the side of the soft fitting member 442 facing the face region and the side of the soft vibration transmission member 432 facing the face region are flush with the face, and the auxiliary face-fitting assembly 44 can have a sufficiently great auxiliary support force, which effectively relieves the support pressure of the vibration plate 431 along its vibration direction and effectively reduces the workload of the transducer 42, thereby effectively improving the sound quality of the bone conduction speaker 40.

Optionally, in some embodiments, the material of the soft vibration transmission member 432 is silicone. Optimally, in other embodiments, the soft vibration transmission member 432 is also made of a material such as rubber, TPU, or TPE.

Optionally, as shown in FIGS. 6, 8, and 11, in some embodiments, the core shell 41 is disposed with an accommodation space 410 with an open end (in some embodiments of the present disclosure, the accommodation space 410 is also referred to as a second accommodation space), and the transducer 42 is disposed within the accommodation space 410. The vibration transmission face-fitting assembly 43 includes the vibration plate 431, the soft vibration transmission member 432, and a rigid bracket 433. A middle region 432a of the soft vibration transmission member 432 is fitted and fixed to the vibration plate 431 in a molding manner, and an edge region 432b of the soft vibration transmission member 432 is fixed to the rigid bracket 433 in a molding manner. The vibration plate 431 is assembled and fixed to the transducer 42, the rigid bracket 433 is assembled and fixed to the core shell 41, and the soft vibration transmission member 432 covers an open end 413 of the core shell 41 and is used for contacting the skin of the human body.

Specifically, the soft vibration transmission member 432 is configured to contact the human skin, i.e., the soft vibration transmission member 432 is in contact with the face region on the front side of the tragus and transmits the sound to the user through the bone conduction, as elaborated above. In this way, the comfort of the bone conduction speaker 40 when transmitting the sound to the user through the bone conduction can be effectively improved. The edge region 432b of the soft vibration transmission member 432 is fixed to the rigid bracket 433 by molding, and the middle region 432a of the soft vibration transmission member 432 is fitted and fixed to the vibration plate 431 by molding. In such cases, an assembly process of the vibration transmission face-fitting assembly 43 may be effectively simplified, an assembly efficiency of the speaker assembly 3 may be effectively improved, and the structural stability of the soft vibration transmission member 432 may be effectively improved, thereby effectively improving the working stability of the bone conduction speaker 40. The edge region 432b of the soft vibration transmission member 432 is fixed to the rigid bracket 433 by molding, and the middle region 432a of the soft vibration transmission member 432 is fixed to the vibration plate 431 by molding. The molding may include injection molding, pressing, etc. For example, the soft vibration transmission member 432 is made by an injection molding process, and during the injection molding process of the soft vibration transmission member 432, the vibration plate 431 and the rigid bracket 433 are placed in a mold for making the soft vibration transmission member 432. When injecting a molding material into the mold for making the soft vibration transmission member 432, the molding material forms a liquid soft vibration transmission member 432 with corresponding shape and structure under the constraint of the mold, and is respectively bonded to corresponding parts of the vibration plate 431 and rigid bracket 433. After the liquid soft vibration transmission member 432 is cooled and solidified, the soft vibration transmission member 432 is formed, and the connections between the soft vibration transmission member 432 and the vibration plate 431, and between the soft vibration transmission member 432 and the rigid bracket 433 are achieved respectively. In this way, the assembly process of the vibration transmission face-fitting assembly 43 may be effectively simplified, the assembly efficiency of the speaker assembly 3 may be effectively improved, and the structural stability of the soft vibration transmission member 432 may also be effectively improved, which effectively improves the working stability of the bone conduction speaker 40. Similar descriptions involving the molding and fixing manners are described herein, the principles of which are as set forth hereinabove, which are not repeated here.

Furthermore, while the rigid bracket 433 is connected to the soft vibration transmission member 432, it is also assembled and fixed to the core shell 41, so as to effectively improve a fixing effect and a mounting structural strength of the vibration transmission face-fitting assembly 43, thereby effectively preventing phenomena affecting the bone conduction sound transmission such as deviation of vibration direction of the vibration transmission face-fitting assembly 43 when the transducer 42 drives the vibration transmission face-fitting assembly 43 to vibrate along the bone conduction vibration direction z1, and thus effectively improving the sound quality of the bone conduction speaker 40.

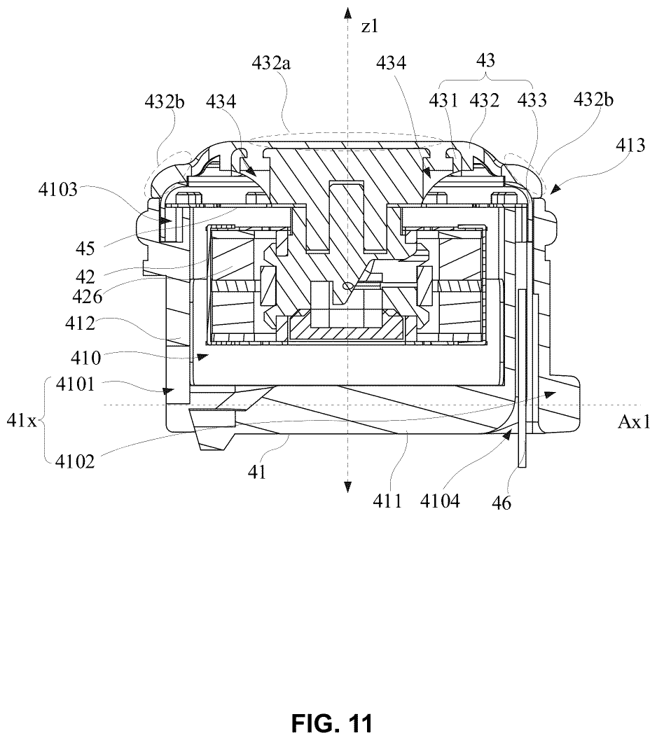

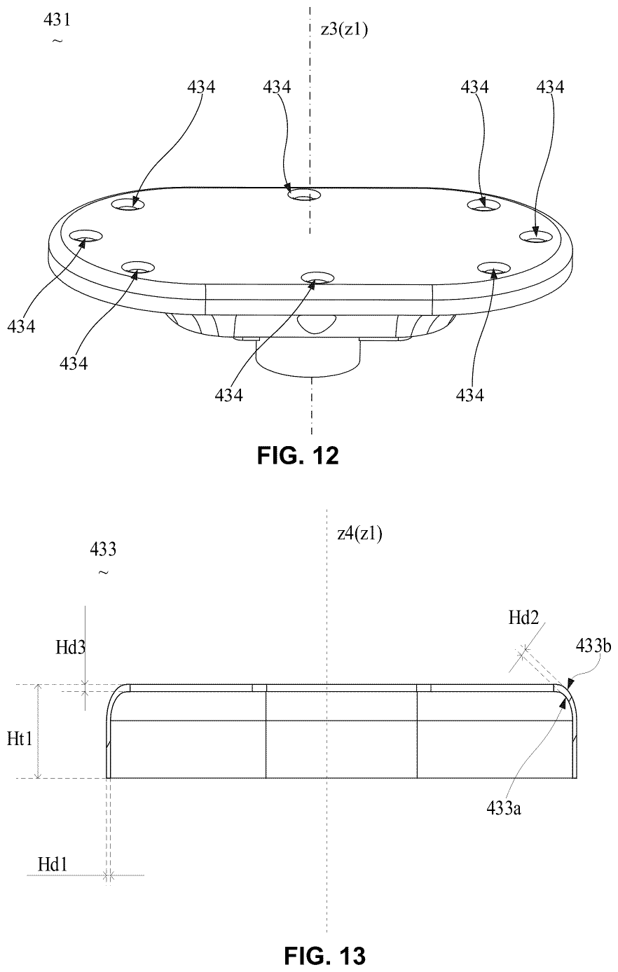

Optionally, as shown in further reference to FIG. 11 and FIG. 12, in some embodiments, a plurality of embedded slots 434 are disposed on the side of the vibration plate 431 facing the soft vibration transmission member 432, and the soft vibration transmission member 432 is molded and embedded within the plurality of embedded slots 434. Specifically, the plurality of embedded slots 434 are disposed on the side of the vibration plate facing the soft vibration transmission member 432, and the soft vibration transmission member 432 is embedded in a molding manner in the plurality of embedded slots 434. In this way, the connection stability between the vibration plate 431 and the soft vibration transmission member 432 is effectively improved.

Optionally, as shown in FIG. 12, in some embodiments, the plurality of embedded slots 434 are disposed close to the edge of the vibration plate 431 and are spaced apart around a central axis z3 of the vibration plate 431 when viewed in the vibration direction of the vibration plate 431. Specifically, the plurality of embedded slots 434 are spaced apart at the edge of the vibration plate 431 around the central axis z3 of the vibration plate 431, so that the connection stability between the vibration plate 431 and the soft vibration transmission member 432 is further improved.

Optionally, as shown in FIGS. 11-12, in some embodiments, the embedded slots 434 are provided to penetrate the side of the vibration plate 431 facing the soft vibration transmission member 432 and the side of the vibration transmission member 432 away from the soft vibration transmission member. The soft vibration transmission member 432 is embedded in the embedded slots 434 in the molding manner and is clamped to the side of the vibration plate 431 away from the soft vibration transmission member 432. In this way, the connection stability between the vibration plate 431 and the soft vibration transmission member 432 may be further improved.

Optionally, as shown in further reference to FIG. 11 and FIG. 13, in some embodiments, the rigid bracket 433 has an annular shape, and the axial direction of the rigid bracket 433 is arranged along the vibration direction of the vibration plate 431. The rigid bracket 433 is plugged with the core shell 41 along an axial direction z4, and is sleeved on the core shell 41. Specifically, the rigid bracket 433 is an annular structure whose axial direction z4 is parallel to the bone guide vibration direction z1. The rigid bracket 433 is plugged with the core shell 41 along the axial direction and sleeved on the core shell 41. In this way, the assembly process between the rigid bracket 433 and the core shell 41 may be effectively simplified, thereby effectively improving the assembly efficiency of the bone conduction speaker 40.

Optionally, as shown in FIG. 13, in some embodiments, a radial thickness Hd1 of the rigid bracket 433 is smaller than an axial height Ht1 of the rigid bracket 433. In this way, while effectively increasing the connection stability between the rigid bracket 433 and the core shell 41, an interference of the rigid bracket 433 to components set its periphery may be effectively reduced.

Optionally, for example, in some embodiments, the radial thickness Hd1 of the rigid bracket 433 is 0.15 mm-0.25 mm, such as 0.16 mm or 0.2 mm, and a thickness of the edge region of the soft vibration transmission member 432, such as a partial structure pointed by arrow 432b, is 0.12 mm-0.18 mm, such as 0.13 mm or 0.15 mm. As another example, in some embodiments, the thickness Hd2 at a bending part of the rigid bracket 433 is 0.2 mm-0.4 mm, such as 0.25 mm or 0.3 mm, a thickness Hd3 at a middle position is 0.15 mm-0.2 mm, such as 0.16 mm or 0.17 mm, the thickness of the middle region 432a of the soft vibration transmission member 432 is 0.3 mm-0.6 mm, such as 0.4 mm, and the thickness of the edge region 432b is 0.4 mm-0.6 mm, such as 0.58 mm.

Optionally, as shown in FIG. 11 and FIG. 13, in some embodiments, the edge region 432b of the soft vibration transmission member 432 is fixed to an inner annular surface 433a or an outer annular surface 433b of the rigid bracket 433 by molding. Specifically, the edge region 432b of the soft vibration transmission member 432 may be fixed to the inner annular surface 433a or the outer annular surface 433b of the rigid bracket 433 by molding. In this way, the soft vibration transmission member 432 and the rigid bracket 433 are connected by a surface, which effectively improves the connection stability between the soft vibration transmission member 432 and the rigid bracket 433.

Optionally, as shown in FIG. 7, FIG. 11, and FIG. 14, in some embodiments, an end surface on a side where the open end 413 of the core shell 41 is located is provided with an annular groove 4103, and the core shell 41 includes an inner housing 4121 and an outer housing 4122 separated by the annular groove 4103 at the end surface and nested with each other. The rigid bracket 433 is embedded within the annular groove 4103 and sleeved on the periphery of the inner housing 4121.

Specifically, the rigid bracket 433 is embedded in the annular groove 4103 and sleeved on the periphery of the inner housing 4121. In this way, the rigid bracket 433 may be connected to the core shell 41 and a portion of the rigid bracket 433 may be effectively hidden within the annular groove 4103, thereby effectively improving the aesthetics of the bone conduction speaker 40. In this embodiment, the core shell 41 is an integrally formed member. The inner housing 4121 and the outer housing 4122 may be understood as, housing portions that are spaced apart by the annular groove 4103 at one end of the core shell 41 and nested with each other. The outer housing 4122 is set on the periphery of the inner housing 4121. Optionally, in other embodiments, the core shell 41 is assembled from the inner housing 4121 and the outer housing 4122. The inner housing 4121 is disposed with the accommodation space 410 for accommodating the transducer 42, and the outer housing 4122 is disposed at the periphery of the inner housing 4121 to form the annular groove 4103.

Optionally, as shown in FIG. 7, FIG. 11, and FIG. 14, in some embodiments, the soft vibration transmission member 432 is fixed to a portion of the outer annular surface 433b of the rigid bracket 433 and abuts the core shell 41. The rigid bracket 433 is embedded in the annular groove 4103 relative to the exposed portion of the soft vibration transmission member 432.

Specifically, the edge region 432b of the soft vibration transmission member 432 is in a curved arc. The edge region 432b of the soft vibration transmission member 432 is fitted to a portion of the outer annular surface 433b of the rigid bracket 433, so that the soft vibration transmission member 432 is fixed to the portion of the outer ring surface 433b of the rigid bracket 433 as a whole. The soft vibration transmission member 432 abuts the outer housing 4122 of the core shell 41, and the exposed portion of the rigid bracket 433 relative to the soft vibration transmission member 432 is embedded in the annular groove 4103. In this way, the rigid bracket 433 may be effectively hidden completely, thereby effectively improving the aesthetic appearance of the bone conduction speaker 40.

Optionally, as shown in FIG. 11, in some embodiments, the transducer 42 includes the magnetic circuit system 426 elastically suspended within the core shell 41, and the rigid bracket 433 is a non-magnetic metal bracket, such as a stainless steel bracket. Specifically, the transducer 42 includes the magnetic circuit system 426, the magnetic circuit system 426 is a magnetic element system elastically suspended within the accommodation space 410. For example, in the embodiment described above, the magnetic circuit system 426 is elastically suspended in the accommodation space 410 through a first vibration transmission sheet. The rigid bracket 433 is connected to the core shell 41 in the above-described manner. By setting the rigid bracket 433 as the non-magnetic metal bracket, the interference of the rigid bracket 433 on the magnetic circuit system 426 may be effectively minimized, thereby effectively improving the vibration stability of the vibration plate 431 driven by the transducer 42, and effectively improving the sound quality of the bone conduction speaker 40. In other embodiments, the rigid bracket 433 is supported by other materials, such as brass, etc.

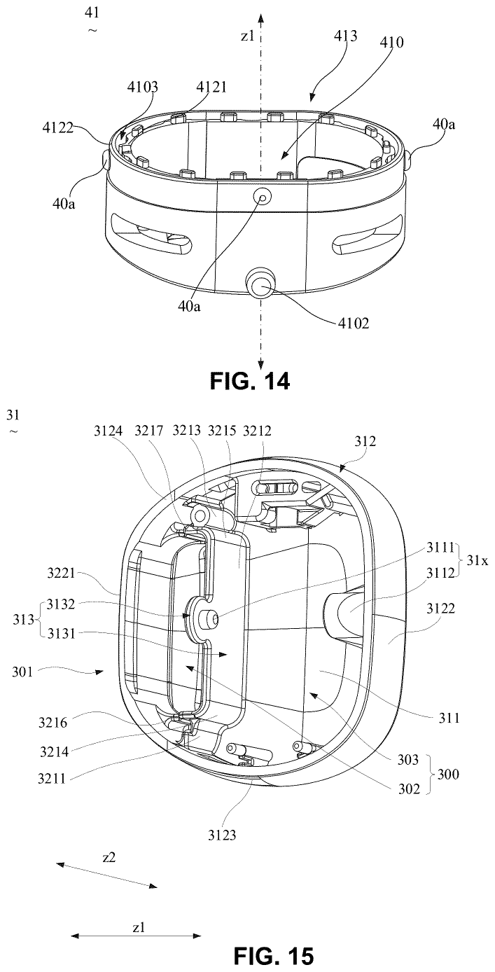

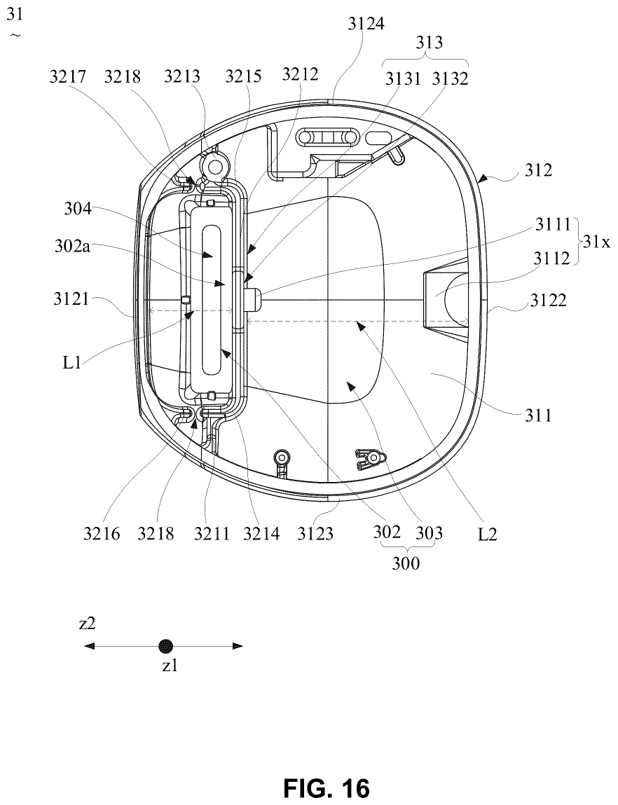

Optionally, referring to FIGS. 6 and 7, and further referring to FIGS. 15 and 16, in some embodiments, as set forth above, the housing assembly 30 includes the main housing 31. The main housing 31 includes a bottom wall 311 and a circumferential sidewall 312 connected to the bottom wall 311 (the circumferential sidewall 312 is also referred to as a first circumferential sidewall in some embodiments, and the bottom wall 311 is also referred to as a first bottom wall in some embodiments) to form an accommodation space 300 (also referred to as a first accommodation space in some embodiments) with an open end. The circumferential sidewall 312 includes a first sidewall 3121 and a second sidewall 3122 disposed opposite to each other, and the main housing 31 also includes a spacer assembly 313 disposed between the first sidewall 3121 and the second sidewall 3122 and at least partially spaced apart from the first sidewall 3121 and the second sidewall 3122. The spacer assembly 313 and the second sidewall 3122 are provided with a first shaft mechanism 3111 and a second shaft mechanism 3112, respectively. The core shell 41 is disposed between the spacer assembly 313 and the second sidewall 3122, and a third shaft mechanism 4101 and a fourth shaft mechanism 4102 are disposed on opposite sides of the core shell 41, respectively. The first shaft mechanism 3111 rotatably cooperates with the third shaft mechanism 4101, and the second shaft mechanism 3112 rotatably cooperates with the fourth shaft mechanism 4102, thereby rotatably supporting the core shell 41 on the main housing 31.

Specifically, as set forth above, the core shell 41 serves as a housing of the bone conduction speaker 40. Main sound generation components in the bone conduction speaker 40, such as the transducer, the vibration transmission face-fitting assembly 43, and the auxiliary face-fitting assembly 44, are disposed on the core shell 41, as described in any of the above embodiments, which is not repeated in detail herein. The bottom wall 311 is connected to the circumferential sidewall 312 to form the accommodation space 300 with the open end as set forth above. The spacer assembly 313 is disposed between the first sidewall 3121 and the second sidewall 3122 to divide the accommodation space 300 into a space between the spacer assembly 313 and the first sidewall 3121 and a space between the spacer assembly 313 and the second sidewall 3122. The space between the spacer assembly 313 and the first sidewall 311 may be used for accommodating other corresponding components of the speaker assembly 3, such as the air conduction speaker 50, etc. (if the speaker assembly 3 only includes the bone conduction speaker 40, then the space between the spacer assembly 313 and the first sidewall 3121 may be used to accommodate other corresponding components), and the space between the spacer assembly 313 and the second sidewall 3122 may be used to accommodate the bone conduction speaker 40. In this way, a space utilization rate of the speaker assembly 3 may be effectively improved.

Further, the spacer assembly 313 and the second sidewall 3122 are respectively provided with a first shaft mechanism 3111 and a second shaft mechanism 3112, and opposite sides of the core shell 41 are respectively disposed with a third shaft mechanism 4101 and a fourth shaft mechanism 4102. The core shell 41 is disposed between the spacer assembly 313 and the second sidewall 3122, the first shaft mechanism 3111 and the third shaft mechanism 4101 rotatably cooperate with each other, and the second shaft mechanism 3112 and the fourth shaft mechanism 4102 cooperate with each other. In this way, the core shell 41 is connected to the main housing 31 while the core shell 41 is capable of rotating relative to the main housing 31, so that the bone conduction speaker 40 can rotate relatively to the main housing 31. In this way, in the wearing state, the bone conduction speaker 40 may adjust a relative positional relationship with the main housing 31 according to a user's face shape, so as to make the vibration plate 431 of the bone conduction speaker 40 fit as closely as possible to the face region on the front side of the user's tragus, thereby effectively improving the bone conduction sound transmission effect of the bone conduction speaker 40, and effectively improving the sound quality of the earphone 1.

Optionally, as shown in FIG. 7, FIG. 15, and FIG. 16, in some embodiments, the spacer assembly 313 is configured to generate an elastic deformation along a spacing direction of the first sidewall 3121 and the second sidewall 3122 when the core shell 41 is assembled to the main housing 31, and an elastic deformation capacity of the spacer assembly 313 along the spacing direction of the first sidewall 3121 and the second sidewall 3122 is greater than that of the first sidewall 3121 and the second sidewall 3122 along the spacing direction of the first sidewall 3121 and the second sidewall 3122. The elastic deformation capacity may be, for example, a degree of deformation generated with the same force applied, or a magnitude of displacement generated. The greater the degree of deformation or the greater the displacement, the greater the elastic deformation capacity, or the smaller the degree of deformation or the smaller the displacement, the smaller the elastic deformation capacity.

Specifically, the spacer assembly 313 is an assembly with a certain elastic deformation capability, so that the spacer assembly 313 generates the elastic deformation along the spacing direction of the first sidewall 3121 and the second sidewall 3122 when the core shell 41 is assembled to the main housing 31 to make enough assembly space for the core shell 41, so that the core shell 41 is smoothly assembled to the main housing 31, thereby effectively improving the assembly efficiency of the core shell 41 and the main housing 31. Furthermore, the elastic deformation capacity of the spacer assembly 313 along the spacing direction of the first sidewall 3121 and the second sidewall 3122 is greater than the elastic deformation capacity of the first sidewall 3121 and the second sidewall 3122 along the spacing direction of the first sidewall 3121 and the second sidewall 3122. In this way, the first sidewall 3121 and the second sidewall 3122 may maintain a sufficiently great structural strength to ensure the connection stability between the core shell 41 and the main housing 31, and the assembly efficiency of the core shell 41 and the main housing 31 is effectively improved.

Optionally, as shown in FIG. 7, FIG. 15, and FIG. 16, in some embodiments, the speaker assembly 3 further includes the air conduction speaker 50, and the air conduction speaker 50 is disposed between the spacer assembly 313 and the first sidewall 3121. In this way, a space between the spacer assembly 313 and the first sidewall 3121 is used to accommodate the air conduction speaker 50, and a space between the spacer assembly 313 and the second sidewall 3122 may be used to accommodate other components such as the bone conduction speaker 40. In this way, the space utilization of the main housing 31 may be effectively improved. After the air conduction speaker 50 is installed in the core shell 41 in the manner described above, an air conduction vibration direction z2 is parallel to the spacing direction of the first sidewall 3121 and the second sidewall 3122.

Optionally, as shown in FIG. 15 and FIG. 16, in some embodiments, the circumferential sidewall 312 further includes a third sidewall 3123 and a fourth sidewall 3124 disposed opposite to each other and connected between the first sidewall 3121 and the second sidewall 3124. The spacer assembly 313 includes a partition body 3131 connected between the third sidewall 3123 and the fourth sidewall 3124 to divide the accommodation space 300 into a first sub-space 302 between the partition body 3131 and the first sidewall 3121 and a second sub-space 303 between the partition body 3131 and the second sidewall 3122. The air conduction speaker 50 is disposed in the first sub-space 302, and a vibration direction of the air conduction speaker 50 points toward or away from the first sidewall 3121. The vibration direction of the bone conduction speaker 40 points toward or away from the bottom wall 311, and a projection of the bone conduction speaker 40 along the vibration direction of the bone conduction speaker 40 falls into the second sub-space 303.

Specifically, the first sub-space 302 between the partition body 3131 and the first sidewall 3121 is also referred to as the space between the spacer assembly 313 and the first sidewall 3121 as described above. The second sub-space 303 between the partition body 3131 and the second sidewall 3122 is also referred to as a space between the spacer assembly 313 and the second sidewall 3122 as set forth above. The partition body 3131 divides the accommodation space 300 into the first sub-space 302 and the second sub-space 303 in the manner described above, the air conduction speaker 50 is disposed in the first sub-space 302, the projection of the bone conduction speaker 40 along the vibration direction of the bone conduction speaker 40 falls into the second sub-space 303, i.e., the bone conduction speaker 40 is supported at a position where the second sub-space 303 is located in the manner set forth in any of the above-described embodiments, so as to effectively improve the space utilization of the main housing 31. Moreover, the vibration direction of the air conduction speaker 50 (also referred to as the air conduction vibration direction z2) points toward or away from the first sidewall 3121, and the vibration direction of the bone conduction speaker 40 (also referred to as the bone conduction vibration direction z1) points toward or away from the bottom wall 311. In this way, the air conduction vibration direction z2 and the bone conduction vibration direction z1 cross each other or are approximately perpendicularly to each other, so that the interference of the bone conduction speaker 40 to the air conduction speaker 50 is effectively reduced, thereby effectively improving the sound quality of the air conduction speaker 50.

Optionally, as shown in FIG. 15 and FIG. 16, in some embodiments, the partition body 3131 includes a first body portion 3211, a second body portion 3212, and a third body portion 3213, which are disposed in sequence in a direction from the third sidewall 3123 to the fourth sidewall 3124. In the spacing direction of the first sidewall 3121 and the second sidewall 3122, the second body portion 3212 is located farther away from the first sidewall 3121 than the first body portion 3211 and the third body portion 3213. The partition body 3131 further includes a first connection portion 3214 connecting the first body portion 3212 and the second body portion 3212 and a second connection portion 3215 connecting the second body portion 3212 and the third body portion 3215 in the spacing direction of the first sidewall 3121 and the second sidewall 3122. An end portion 51 of the air conduction speaker 50 facing the second sidewall 3122 is embedded between the first connection portion 3214 and the second connection portion 3215.

Specifically, through the above arrangement, the first connection portion 3214, the second connection portion 3215, and the second body portion 3212 enclose a positioning space 302a with a positioning function on a side of the first connection portion facing the first sidewall 3121, a side of the second connection portion 3215 facing the first sidewall 3121, and a side of the second body portion 3212 facing the first sidewall 3121. The end portion 51 of the air conduction speaker 50 facing the second sidewall 3122 is embedded in the positioning space 302a. The positioning space 302a is capable of efficiently positioning the air conduction speaker 50, thereby effectively improving the installation accuracy of the air conduction speaker 50.

Optionally, referring to FIGS. 15-17, in some embodiments, the partition body 3131 further includes a third connection portion 3216 connecting the first body portion 3211 and the first sidewall 3121 and a fourth connection portion 3217 connecting the third body portion 3213 and the first sidewall 3121 along the spacing direction of the first sidewall 3121 and the second sidewall 3122. The third connection portion 3216 and the fourth connection portion 3217 are disposed with a slot 3218, respectively. The air conduction speaker 50 is provided with flange portions 332 embedded in the slots 3218.

Specifically, in the assembling process of the air conduction speaker 50 and the main housing 31, the flange portions 332 are snapped with the slots 3218, so as to enable the third connection portion 3216 and the fourth connection portion 3217 to effectively position the air conduction speaker 50, which effectively prevents a relative position of the air conduction speaker 50 and the main housing 31 from deviating during the assembly process, thereby effectively improving the installation accuracy of the air conduction speaker 50.

Optionally, referring to FIG. 15 and FIG. 16, in some embodiments, a size L1 of the first sub-space 302 along the spacing direction of the first sidewall 3121 and the second sidewall 3122 is less than a size L2 of the second sub-space 303 along the spacing direction of the first sidewall 3121 and the second sidewall 3122.

Specifically, the air conduction speaker 50 generates sound by vibrating air to be exported from the sound outlet, and the bone conduction speaker 40 generates sound by vibrating through the vibration transmission face-fitting assembly 43 that is fitted to the face. To make a sound transmission effect of the air conduction speaker 50 and a sound transmission effect of the bone conduction speaker 40 match better to effectively improve the sound quality of the speaker assembly 3, and considering the sensitivity and an operation manner of face-fitting and vibration, an overall structural size of the bone conduction speaker 40 is greater than that of the air conduction speaker 50. Therefore, by setting the size L1 of the first sub-space 302 along the spacing direction of the first sidewall 3121 and the second sidewall 3122 to be smaller than the size L2 of the second sub-space 303 along the spacing direction of the first sidewall 3121 and the second sidewall 3122, the second sub-space 303 is made to have a greater spatial volume, thereby enabling the main housing 31 to accommodate the bone conduction speaker 40 with greater structural size, so as to enable the bone conduction speaker 40 to have a better vibration effect, and make the sound transmission effect of the bone conduction speaker 40 and the sound transmission effect of the air conduction speaker 50 better matched, thereby effectively improving the sound quality of the bone conduction speaker 40.

Optionally, referring to FIGS. 7, 15, and 16, in some embodiments, the air conduction speaker 50 is inserted into the first sub-space 302 from the open end 301 of the main housing 31, and the vibration direction of the air conduction speaker 50 (the air conduction vibration direction z2) is perpendicular to an insertion direction of the air conduction speaker 50 relative to the first sub-space 302, and a size of the air conduction speaker 50 along the vibration direction is less than a size of the air conduction speaker 50 along a direction perpendicular to the vibration direction of the air conduction speaker 50.

Specifically, the size of the air conduction speaker 50 along the air conduction vibration direction z2 includes a thickness of the air conduction speaker 50, and the size of the air conduction speaker 50 along the direction perpendicular to the air conduction vibration direction z2 includes a width and a length of the air conduction speaker 50. When the overall structural size of the air conduction speaker 50 remains unchanged, the thickness of the air conduction speaker 50 is set to be less than the length and a width of the air conduction speaker 50. In this way, the sound generation effect of the air conduction speaker 50 may be effectively ensured while the size of the air conduction speaker 50 (i.e., the thickness of the air conduction speaker 50) in the air conduction vibration direction z2 may be effectively reduced. Further, based on the above-described structural sizes, the air conduction speaker 50 is inserted into the first sub-space 302 along the insertion direction perpendicular to the air conduction vibration direction z2, which effectively reduces the space size occupied by the air conduction speaker 50 on the main housing 31 along the air conduction vibration direction z2. The second sub-space 303 has a greater size along the air conduction vibration direction z2 such that the space utilization rate of the main housing 31 in the air conduction vibration direction z2 is effectively improved, so that the main housing 31 can accommodate the bone conduction speaker 40 with greater structural size, thereby effectively improving the sound quality of the speaker assembly 3. In some embodiments, the bone conduction vibration direction z1 serves as a reference direction for the insertion direction.

Optionally, referring to FIG. 15 and FIG. 16, in some embodiments, the spacer assembly 313 further includes an elastic arm 3132 connected to a side of the partition body 3131 away from the bottom wall 311. A size of the elastic arm 3132 along the spacing direction of the third sidewall 3123 and the fourth sidewall 3124 is smaller than a size of the partition body 3131 along the spacing direction of the third sidewall 3123 and the fourth sidewall 3124, and the first shaft mechanism 3111 is disposed on the elastic arm 3132.

Specifically, the elastic arm 3132 is connected to the side of the partition body 3131 away from the bottom wall 311, for example, in some embodiments, the elastic arm 3132 is connected to the side of the second body portion away from the bottom wall 311. The first shaft mechanism 3111 is disposed on the elastic arm 3132. The elastic arm 3132 has an elastic deformation capability along the spacing direction. When the core shell 41 is assembled with the main housing 31, the elastic arm 3132 elastically deforms in the spacing direction of the first sidewall 3121 and the second sidewall 3122 to leave a sufficiently great assembly space for the core shell 41, so that the first shaft mechanism 3111 and the third shaft mechanism 4101, as well as the second shaft mechanism 3112 and the fourth shaft mechanism 4102, may easily and quickly cooperate with each other, thereby effectively improving the assembly efficiency of the core shell 41 and the main housing 31.

Optionally, referring to FIG. 15 and FIG. 16, in some embodiments, the elastic arm 3132 further elastically abuts the side of the air conduction speaker 50 away from the first sidewall 3121.

Specifically, after the bone conduction speaker 40 is supported in the second sub-space 303 in the above-described manner, the elastic arm 3132 is squeezed by the bone conduction speaker 40 and elastically deforms toward the air conduction speaker 50, so that the elastic arm 3132 abuts the air conduction speaker 50 and provides an abutment force for the air conduction speaker 50, which effectively improves a fixing effect between the air conduction speaker 50 and the main housing 31.

Optionally, in some embodiments, the main housing 31 and the spacer assembly 313 are integrally molded, the first shaft mechanism 3111 is a rotating shaft, and the third shaft mechanism 4101 is a rotating slot that receives the rotating shaft.

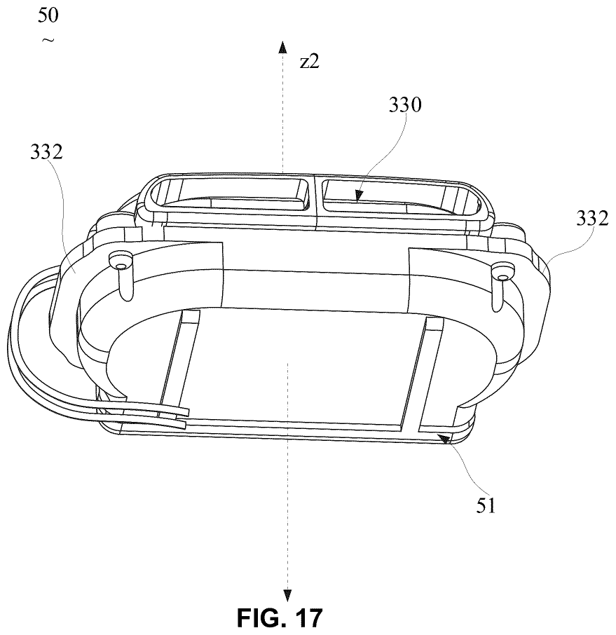

Optionally, referring to FIG. 6, FIG. 7, and FIG. 17, in some embodiments, the housing assembly 30 further includes the main cover body 32 covering the open end 301 of the main housing 31, the air conduction speaker 50 is disposed with a first sound outlet 330. The first sound outlet 330 is disposed facing the main cover body 32, and the main cover body 32 is disposed with a second sound outlet 321 corresponding to the first sound outlet 330.

Specifically, the housing assembly 30, as a member for accommodating and supporting the air conduction speaker 50 and/or the bone conduction speaker 40, includes the main housing 31 and the main cover body 32 detachably connected to each other. After the air conduction speaker 50 and/or the bone conduction speaker 40 are fixed to the main housing 31 in the manner described above, the main cover body 32 is covered on the open end 301 of the main housing 31. In this way, an assembly interference caused by a shell of the main cover body 32 of the housing assembly 30 during the installation of the air conduction speaker 50 and/or the bone conduction speaker 40 may be avoided effectively, thereby effectively improving the installation efficiency of the speaker assembly 3. Furthermore, the air conduction speaker 50 and the main cover body 32 are disposed with the first sound outlet 330 and the second sound outlet 321, respectively, and the first sound outlet 330 is disposed in correspondence with the second sound outlet 321, so that the sound generated by the air conduction speaker 50 passes through the first sound outlet 330 and the second sound outlet 321 and transmits to the user's ear more efficiently, which effectively improves the sound transmission effect of the air conduction speaker 50.

Optionally, referring to FIGS. 5, 6, and 7, and further referring to FIG. 15, in some embodiments, as set forth above, the bone conduction speaker 40 includes the transducer 42 and the vibration plate 431. The transducer 42 is disposed in the core shell 41, and the vibration plate 431 is connected to the transducer 42 (the connection relationship between the transducer 42 and the core shell 41 and the vibration plate 431 t may be referred to in any embodiments regarding the transducer 42, which is not repeated herein), the first shaft mechanism 3111 and the second shaft mechanism 3112 are protrudingly disposed outside the open end 301 of the main housing 31, the main cover body 32 is disposed with an opening 320, and the core shell 41 and the vibration plate 431 are exposed through the opening 320 of the main cover body 32.

Specifically, the core shell 41 is connected to the first shaft mechanism 3111 and the second shaft mechanism 3112 via the third shaft mechanism 4101 and the fourth shaft mechanism 4102, respectively. The first shaft mechanism 3111 and the second shaft mechanism 3112 are protrudingly disposed outside the open end 301 of the main housing 31, so that members such as the core shell 41 and the vibration plate 431 are exposed through the openings 320 of the main cover body 32, so that the bone conduction speaker 40 does not occupy the second sub-space 303 excessively. In this way, the volume of the second sub-space 303 can be made smaller, so as to effectively reduce the volume of the main housing 31, and effectively improve the spatial utilization rate of the speaker assembly 3.

Optionally, referring to FIG. 2 and FIG. 7, in some embodiments, the speaker assembly 3 further includes the battery 61 or the control circuit board 62 disposed within the second sub-space 303. The battery 61 supplies power to the air conduction speaker 50 and the bone conduction speaker 40 through the control circuit board 62, and the control circuit board 62 is used to control the air conduction speaker 50 and bone conduction speaker 40 to vibrate.

Specifically, a portion of the space of the second sub-space 303 is configured for setting the bone conduction speaker 40, and the remaining portion is configured for setting the battery 61 or the control circuit board 62. In this way, the space utilization rate of the main housing 31 is effectively improved, thus further optimizing the overall structural size of the speaker assembly 3. As described above, the speaker assembly 3 is applied to the earphone 1. The earphone 1 includes two speaker assemblies 3, with the battery 61 disposed on one speaker assembly 3 and the control circuit board 62 disposed on the other speaker assembly 3.

Optionally, referring to FIGS. 6-7, in some embodiments, the speaker assembly 3 includes: the housing assembly 30, the air conduction speaker 50, and the bone conduction speaker 40, and the housing assembly 30 includes the main housing 31. The air conduction speaker 50 is disposed in the main housing 31 by way of any of the embodiments of the present disclosure. The bone conduction speaker 40 is rotatably supported on the main housing 31 and is capable of rotating with respect to the main housing 31 along a preset rotation axis Ax1. The vibration direction (the air conduction vibration reversal z2) of the air conduction speaker 50 is parallel to the preset rotation axis Ax1, and the vibration direction (the bone conduction vibration direction z1) of the bone conduction speaker 40 is perpendicular to the rotation axis Ax1.

Specifically, for example, as illustrated in the above embodiments, the first shaft mechanism 3111 and the second shaft mechanism 3112 are disposed on the main housing 31, and the third shaft mechanism 4101 and the fourth shaft mechanism 4102 are disposed on the core shell 41. The first shaft mechanism 3111 and the third shaft mechanism 4101 are rotatably connected, and the second shaft mechanism 3112 and the fourth shaft mechanism 4102 are rotatably connected. In this way, the bone-conduction speaker 40 is rotatably supported on the main housing 31. The bone conduction speaker 40 is rotatably connected to the main housing 31 so that the bone conduction speaker 40 rotates related to the main housing 31. In the wearing state, the relative position relationship between the bone conduction speaker 40 and the main housing 31 can be adjusted according to the user's face shape, so that the vibration plate 431 of the bone conduction speaker 40 fits as closely as possible to the face region on the front side of the user's tragus, thereby effectively improving the sound transmission effect of the bone conduction speaker 40, and effectively improving the sound quality of the bone conduction speaker 40.

Further, the vibration direction of the air conduction speaker 50 (i.e., the air conduction vibration direction z2) and the rotation axis Ax1 are parallel to each other. In this way, the interference of the air conduction speaker 50 to the bone conduction speaker 40 may be effectively minimized. For example, by setting the air conduction vibration direction z2 to be parallel to the rotation axis Ax1, the air conduction speaker 50 can be effectively prevented from driving the bone conduction speaker 40 to rotate around the rotation axis Ax1 when the air conduction speaker 50 is in operation. The vibration direction of the bone conduction speaker 40 is perpendicular to the rotation axis Ax1, that is to say, the bone conduction vibration direction z1 is set perpendicular to the air conduction vibration direction z2. In this way, the interference of the bone conduction speaker 40 on the air conduction speaker 50 may be effectively reduced, thereby effectively improving the sound quality of the air conduction speaker 50.

Optionally, referring to FIG. 7, in some embodiments, the main housing 31 includes a first bottom wall and a first circumferential sidewall connected to the first bottom wall (in some embodiments, the first bottom wall is also referred to as the bottom wall 311, and the first circumferential sidewall is also referred to as the circumferential sidewall 312) to form a first accommodation space with an opening end (in some embodiments, the first accommodation space is also referred to as the accommodation space 300). The air conduction speaker 50 and the bone conduction speaker 40 are placed within the first accommodation space from the open end 301 of the main housing 31, and the vibration direction of the air conduction speaker 50 points toward or away from the first circumferential sidewall, and the vibration direction of the bone conduction speaker 40 points toward or away from the first bottom wall.

Specifically, referring to FIG. 7, and further referring to FIGS. 8, 11, 15, and 16, in some embodiments, the main housing 31 and the core shell 41 are each disposed with a shaft mechanism that cooperates in a detachable manner (in some embodiments, the shaft mechanism includes a shaft mechanism 31x disposed on the main housing 31 and a shaft mechanism 41x disposed on the core shell 41. The shaft mechanism 31x includes the first shaft mechanism 3111 and the second shaft mechanism 3112 disposed on the main housing 31 as described above, and the shaft mechanism 41x includes the third shaft mechanism 4101 and the fourth shaft mechanism 4102 disposed on the core shell 41 described above, which is not repeated herein), and the core shell 41 is rotatably cooperated with the shaft mechanism 31x through the shaft mechanism 41x to be rotatably supported on the main housing 31. In this way, the main housing 31 and the core shell 41 are detachably connected through the shaft mechanism 31x and the shaft mechanism 41x, thereby effectively improving the assembly efficiency of the main housing 31 and the core shell 41.

Optionally, in some embodiments, as set forth above, referring to FIGS. 1, 6 and 8, the speaker assembly 3 includes the housing assembly 30, the air conduction speaker 50, and the bone conduction speaker 40. The bone conduction speaker 40 is set eccentrically with respect to the housing assembly 30. The bone conduction speaker 40 includes the vibration transmission face-fitting assembly 43, the vibration transmission face-fitting assembly 43 contacts the face region at the front of the tragus of the user in the wearing state, and is used to conduct bone conduction sound waves. The air conduction speaker 50 is disposed in the housing assembly 30, the air conduction speaker 50 is disposed with the first sound outlet 330. The housing assembly 30 is disposed with the second sound outlet 321 corresponding to the first sound outlet 330. When viewed in the vibration direction (i.e., the bone conduction vibration direction z1) of the bone conduction speaker 40, the second sound outlet 321 is located at the periphery of the vibration transmission face-fitting assembly 43 and is used for conducting the air conduction sound waves.

Specifically, as set forth above, the bone conduction speaker 40 conducts sound to the user through bone conduction. The transducer 42 is a device that converts an electrical signal into vibration and is connected to the vibration plate 431 and drives the vibration plate 431 to vibrate based on the corresponding electrical signal. The vibration direction of the vibration plate 431 is also referred to as the bone conduction vibration direction z1, which is the vibration direction of the bone conduction speaker 40 when it is operating. The air conduction speaker 50 is disposed with the first sound outlet 330, and the housing assembly 30 is disposed with the second sound outlet 321. For example, the second sound outlet 321 is disposed on the main cover body 32, the first sound outlet 330 is disposed facing the main cover body 32, and the main cover body 32 is disposed with the second sound outlet 321 corresponding to the first sound outlet 330. The sound generated by the air conduction speaker 50 is emitted from the first sound outlet 330 and directed to the user's ear through the second sound outlet 321. In this way, the sound emitted from the air conduction speaker 50 is efficiently transmitted to the user's ear, thereby effectively improving the sound transmission effect of the air conduction speaker 50, so as to effectively improve the sound quality of the sound transmitted from the air conduction speaker 50 to the user. In the wearing state, when viewed in the bone conduction vibration direction z1, the second sound outlet 321 is located at the periphery of the vibration transmission face-fitting assembly 43. In this way, a sound transmission interference of the bone conduction speaker 40 to the air conduction speaker 50 is effectively reduced, thereby effectively improving the sound transmission effect of the air conduction speaker 50 and effectively improving the sound quality of the sound transmitted from the air conduction speaker 50 to the user.

Optionally, in some embodiments, the bone conduction speaker 40 further includes the core shell 41, the transducer 42, and the auxiliary face-fitting assembly 44. The housing assembly 30 includes the main housing 31, the core shell 41 is supported on the main housing 31, and the transducer 42 is disposed in the core shell 41. The vibration transmission face-fitting assembly 43 includes the vibration plate 431 connected to the transducer 42 and in direct or indirect contact with the face region on the front side of the user's tragus in the wearing state. The auxiliary face-fitting assembly 44 is connected to the core shell 41, and when viewed in the vibration direction of the vibration plate 431, the auxiliary face-fitting assembly 44 surrounds the periphery of the vibration plate 431 along the circumference of the vibration plate 431. Further referring to FIG. 7, FIG. 8, and FIG. 17, the width of the auxiliary face-fitting assembly 44 on a side facing the tragus is less than the width of the auxiliary face-fitting assembly 44 on a side away from the tragus, and the auxiliary face-fitting assembly 44 is configured to contact the face region at the periphery of the vibration plate 431 in the wearing state. The air conduction speaker 50 is disposed in the housing assembly 30, the air conduction speaker 50 is disposed with the first sound outlet 330, the housing assembly 30 is disposed with the second sound outlet 321 corresponding to the first sound outlet 330, and when viewed in the vibration direction of the vibration plate 431, the second sound outlet 321 is disposed between the vibration plate 431 and the tragus and is disposed at least partially at the periphery of the auxiliary face-fitting assembly 44.

Specifically, the bone conduction speaker 40 conducts sound to the user through bone conduction, as set forth above. The transducer 42 is a device that converts the electrical signal into the vibration, which is connected to the vibration plate 431 and drives the vibration plate 431 to vibrate based on the corresponding electrical signal. The vibration direction of the vibration plate 431 is also referred to as the bone conduction vibration direction z1, which is the vibration direction of the bone conduction speaker 40 when it is operating. The vibration plate 431, as a main component of the vibration transmission face-fitting assembly 43, is in direct or indirect contact with the face region on the front side of the user's tragus when the earphone 1 is in the wearing state. In this way, driven by the transducer 42, the vibration plate 431 conducts sound to the user through bone conduction. In some embodiments, the contact between the vibration plate 431 and the face region on the front side of the user's tragus is indirect, i.e., contact via the soft vibration transmission member 432. In any of the embodiments of the bone conduction speaker 40, descriptions regarding the contact between the vibration plate 431 and the face region on the front side of the user's tragus are understood as that the vibration plate 431 is in indirect contact with the face region on the front side of the tragus via the soft vibration transmission member 432. For example, as set forth above, the vibration transmission face-fitting assembly 43 further includes the soft vibration transmission member 432 and the rigid bracket 433, an edge region 432b of the soft vibration transmission member 432 is fixed to the rigid bracket 433 by molding, the soft vibration transmission member 432 has a middle region 432a that is fixed to the vibration plate 431 by molding, and a specific structure of the vibration transmission face-fitting assembly 43 may be found above, which is not discussed in detail herein. The soft vibration transmission member 432 is connected to the vibration plate 431 in the manner described above for direct contact with human skin, i.e., the soft vibration transmission member 432 is in contact with the face region on the front side of the tragus and transmits the sound to the user through bone conduction, as described above. In this way, the comfort of the bone conduction speaker 40 in transmitting the sound to the user through the bone conduction vibration may be effectively improved.

Further, the auxiliary face-fitting assembly 44 plays the role of auxiliary support, and in the wearing state, the auxiliary face-fitting assembly 44 contacts the face region on the front side of the tragus of the user to play the role of auxiliary support for the bone conduction speaker 40 along the bone conduction vibration direction z1. In this way, the support pressure of the vibration plate 431 along its vibration direction may be effectively relieved, thereby effectively reducing the workload of the transducer 42, so as to effectively improve the sound quality of the bone conduction speaker 40. When viewed along the bone conduction vibration direction z1, the auxiliary face-fitting assembly 44 surrounds the periphery of the vibration plate 431 in the circumferential direction of the vibration plate 431. In this way, the periphery of the vibration plate 431 may be supported by the auxiliary face-fitting assembly 44, thereby effectively improving the positioning effect of the auxiliary face-fitting assembly 44 on the vibration plate 431.

Furthermore, when viewed in the vibration direction of the vibration plate 431, the width of the side of the auxiliary face-fitting assembly 44 facing the tragus is smaller than the width of the side of the auxiliary face-fitting assembly 44 away from the tragus. In this way, the vibration plate 431 as a whole may be closer to the user's tragus, thereby effectively improving the sound transmission effect of the bone conduction speaker 40, and effectively improving the sound quality of the bone conduction speaker 40. The specific structure of the auxiliary face-fitting assembly 44 may be found in any of the embodiments of the auxiliary face-fitting assembly 44 of the present disclosure. The air conduction speaker 50 is disposed with the first sound outlet 330, and the housing assembly 30 is disposed with the second sound outlet 321. For example, the second sound outlet 321 is disposed on the main cover body 32, the first sound outlet 330 is disposed facing the main cover body 32, and the main cover body 32 is disposed with the second sound outlet 321 corresponding to the first sound outlet 330. The sound generated by the air conduction speaker 50 is emitted from the first sound outlet 330 and directed to the user's ear through the second sound outlet 321. In this way, the sound emitted from the air conduction speaker 50 is efficiently transmitted to the user's ear, thereby effectively improving the sound transmission effect of the air conduction speaker 50, so as to effectively improve the sound quality of the sound transmitted from the air conduction speaker 50 to the user. In the wearing state, when viewed in the vibration direction of the vibration plate 431, the second sound outlet 321 is located between the vibration plate 431 and the tragus. In this way, the second sound outlet 321 is set closer to the user's ear, thereby enabling the sound generated by the air conduction speaker 50 to be efficiently conducted into the user's ear through the second sound outlet 321, and effectively improving the sound transmission effect of the air conduction speaker 50, so as to efficiently improve the sound quality transmitted by the air conduction speaker 50 to the user.

Optionally, referring to FIG. 4, FIG. 6, FIG. 7, and FIG. 16, in some embodiments, the housing assembly 30 includes the main cover body 32 that is covered on the open end 301 of the main housing 31, as set forth above. The air conduction speaker 50 is disposed with the first sound outlet 330 facing the main cover body 32, and the main cover body 32 is disposed with the second sound outlet 321 corresponding to the first sound outlet 330. The sound generated by the air conduction speaker 50 is emitted from the first sound outlet 330 and is directed to the ear of the user through the second sound outlet 321.

Specifically, as set forth above, the housing assembly 30, as a component for accommodating and supporting the air conduction speaker 50 and/or the bone conduction speaker 40, includes the main housing 31 and the main cover body 32 detachably connected. The air conduction speaker 50 and/or the bone conduction speaker 40 are fixed to the main housing 31 in the manner described above, and then the main cover body 32 is covered on the open end 301 of the main housing 31. In this way, the assembly interference caused by the shell of the main cover body 32 of the housing assembly 30 may be effectively avoided during the installation of the air conduction speaker 50 and/or bone conduction speaker 40, so as to effectively improve the installation efficiency of the speaker assembly 3. Furthermore, the air conduction speaker 50 and the main cover body 32 are disposed with the first sound outlet 330 and the second sound outlet 321, respectively, and the first sound outlet 330 is disposed in correspondence with the second sound outlet 321, so that the sound generated by the air conduction speaker 50 is conducted to the user's ear more efficiently through the first sound outlet 330 and the second sound outlet 321, which effectively improves the sound transmission effect of the air conduction speaker 50.

Optionally, in some embodiments, in the wearing state, the vibration plate 431 is in direct or indirect contact with the face region on the front side of the user's tragus, and when viewed in the vibration direction of the vibration plate 431, the second sound outlet 321 is disposed between the vibration plate 431 and the tragus. In this way, the sound generated by the air conduction speaker 50 is efficiently conducted into the user's ear through the second sound outlet 321, thereby effectively improving the sound transmission effect of the air conduction speaker 50, so as to effectively improve the sound quality of the sound transmitted by the air conduction speaker 50 to the user.

Optionally, in some embodiments, in the wearing state, the second sound outlet 321 is disposed facing the human ear. In this way, the sound generated by the air conduction speaker 50 is more efficiently directed into the user's ear through the second sound outlet 321, thereby effectively improving the sound transmission effect of the air conduction speaker 50, so as to effectively improve the sound quality of the sound transmitted from the air conduction speaker 50 to the user.

Optionally, as shown in FIG. 6 and FIG. 7, in some embodiments, the housing assembly 30 further includes the main cover body 32. The main housing 31 includes the bottom wall 311 and the circumferential sidewall 312 connected to the bottom wall 311 to form the accommodation space 300 with the open end, the main cover body 32 covers the open end of the main housing 31, and the air conduction speaker 50 is disposed in the accommodation space 300. The second sound outlet 321 is disposed on the main cover body 32, the main cover body 32 is disposed with an opening 320, and the core shell 41 and the vibration plate 431 are exposed through the opening 320. For example, as set forth above, the main housing 31 is disposed with the first shaft mechanism 3111 and the second shaft mechanism 3112, and the core shell 41 is disposed with the third shaft mechanism 4101 and the fourth shaft mechanism 4102. The first shaft mechanism 3111 and the second shaft mechanism 3112 are protrudingly disposed outside the open end 301 of the main housing 31. The first shaft mechanism 3111 rotatably cooperates with the third shaft mechanism 4101, and the second shaft mechanism 3112 rotatably cooperates with the fourth shaft mechanism 4102, so that the bone conduction speaker 40 (the bone conduction speaker 40 as set forth above at least includes the core shell 41 and vibration plate 431) is supported on the accommodation space 300 as a whole, and the core shell 41 and the vibration plate 431 are exposed through the opening 320 of the main cover body 32. In this way, the bone conduction speaker 40 does not occupy too much space in the accommodation space 300 (the second sub-space 303) after being assembled with the main housing 31, so that the volume of the accommodation space 300 (e.g., the second sub-space 303) may be made smaller, and the volume of the main housing 31 is smaller, thus effectively improving the space utilization rate of the speaker assembly 3.

Optionally, as shown in FIG. 4, FIG. 5, FIG. 6, FIG. 7, FIG. 16, and FIG. 17, in some embodiments, the air conduction speaker 50 is inserted into the accommodation space 300 from the open end of the main housing 31, and the air conduction speaker 50 is further disposed with a first pressure relief hole 331. The first sound outlet 330 and the first pressure relief hole 331 are disposed opposite to each other along the insertion direction of the air conduction speaker 50 relative to the main housing 31. In this way, interference caused between a pressure relief through the first pressure relief hole 331 and the sound transmission through the first sound outlet 330 of the air conduction speaker 50 may be reduced, thereby effectively improving the sound quality of the air conduction speaker 50. The bottom wall 311 is deposed with a second pressure relief hole 304 corresponding to the first pressure relief hole 331. Specifically, the bottom wall 311 is disposed opposite to the first pressure relief hole 331, and the second pressure relief hole 304 is disposed on the bottom wall 311, such that the air relieved by the air conduction speaker 50 through the first pressure relief hole 331 may be relieved to the external space of the speaker assembly 3 through the second pressure relief hole 304 more efficiently, thereby achieving more efficient pressure relief.

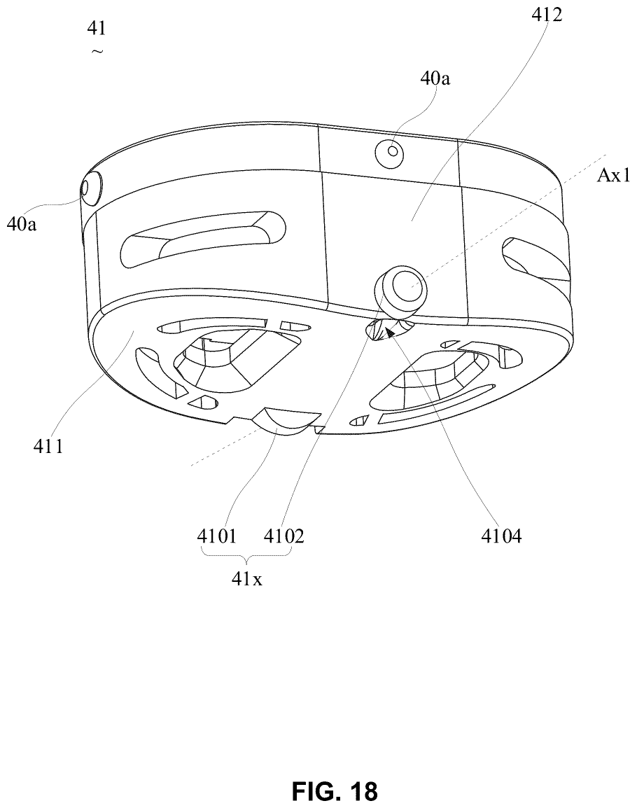

Optionally, as shown in FIG. 11 and FIG. 18, in some embodiments, the bone conduction speaker 40 further includes a lead 46, and the core shell 41 is disposed with a housing lead hole 4104. The lead 46 extends into the core shell 41 through the housing lead wire hole 4104 and is electrically connected to the transducer 42. An extension direction of the housing lead hole 4104 intersects the rotation axis Ax1.

Specifically, the lead 46 is configured to electrically connect to the transducer 42 to direct the electrical signal to the transducer 42. The housing lead hole 4104 is configured to guide the lead 46, which is connected to the transducer 42 in the core shell 41, to a functional space outside the core shell 41. The housing lead hole 4104 is disposed on the core shell 41, and the lead 46 extends into the core shell 41 through the housing lead hole 4104 to be electrically connected to the transducer 42. The extension direction of the housing lead hole 4104 (the extension direction of the housing lead hole 4104 is a direction perpendicular to a bottom shell wall 411 of the core shell 41) intersects with the rotation axis Ax1. In this way, a stretching of the lead 46 when the bone conduction speaker 40 rotates around the rotation axis Ax1 may be effectively reduced, thereby effectively improving the service life of the lead 46.

Optionally, as shown in FIGS. 7, 11, 14, and 18, in some embodiments, the core shell 41 includes a second bottom wall and a second circumferential sidewall connected to the second bottom wall (in some embodiments, the second bottom wall is also referred to as the bottom shell wall 411, and the second circumferential sidewall is also referred to as a circumferential shell wall 412), to form a second accommodating space with an open end (in some embodiments, the second accommodation space is also referred to as the accommodation space 410). The transducer 42 is disposed in the second accommodation space. The second bottom wall is disposed facing the first bottom wall 311 (also referred to as the bottom wall) relative to the open end 413 of the core shell 41. The housing lead hole 4104 is disposed in the second bottom wall, the shaft mechanism 41x on the core shell 41 is disposed on the second circumferential sidewall, the speaker assembly 3 further includes the control circuit board 62 disposed between the first bottom wall 311 and the core shell 41, and the lead 46 connects the control circuit board 62.

Specifically, the second bottom wall is connected to the second circumferential sidewall to form the second accommodation space with the open end for accommodating the transducer 42. The end of the core shell 41 is an end of the second circumferential sidewall away from the first bottom wall (i.e., the bottom wall 311), as set forth above. In the bone conduction vibration direction z1, the second bottom wall is located between the second circumferential sidewall and the first bottom wall, i.e., the second bottom wall is disposed facing the first bottom wall relative to the open end 413 of the core shell 41. The shaft mechanism 41x (e.g., the third shaft mechanism 4101 and the fourth shaft mechanism 4102) on the core shell 41 is disposed on the second circumferential sidewall, and the control circuit board 62 is disposed between the first bottom wall and the core shell 41, i.e., the control circuit board 62 is disposed between the first bottom wall and the second bottom wall, so as to efficiently utilize an vacated excess space between the second bottom wall and the core shell 41, and improve the space utilization rate of the main housing 31.

Optionally, as shown in FIGS. 11, 15, and 18, in some embodiments, in the vibration direction of the vibration plate 431 (i.e., in the bone conduction vibration direction z1), a distance between the shaft mechanism 41x on the core shell 41 and the second bottom wall is less than a distance between the shaft mechanism 41x on the core shell 41 and the open end 413 of the core shell 41.

Specifically, in the bone conduction vibration direction z1, the distance between the shaft mechanism 41x on the core shell 41 and the second bottom wall is less than the distance between the shaft mechanism 41x on the core shell 41 and the open end 413 of the core shell 41, which makes the shaft mechanism 41x closer to the second bottom wall of the core shell 41. That is, the shaft mechanism 41x is closer to the bottom of the core shell 41, thereby enabling the bone conduction speaker 40 as a whole to protrude mostly from the second sub-space, thereby effectively reducing the occupancy of the second sub-space by the bone conduction speaker 40. Furthermore, the shaft mechanism 41x and the second bottom wall are approximately arranged on the same plane. In this way, the housing lead hole 4104 is set on the second bottom wall and the extension direction of the housing lead hole 4104 intersects the rotation axis Ax1, which effectively reduces the stretching of the lead 46 when the bone guide speaker 40 rotates around the rotation axis Ax1, thereby effectively improving the service life of the lead 46. The shaft mechanism 41x is located on approximately the same plane with the second bottom wall, so that the bone conduction speaker 40 as a whole protrudes from the second sub-space, thereby effectively reducing the occupancy of the bone conduction speaker 40 on the second sub-space.

In conjunction with FIG. 1, embodiments of the present disclosure provide the earphone 1. The earphone 1 includes the wearing assembly 2 and the speaker assembly 3, and the wearing assembly 2 is fixedly connected to the housing assembly 30 of the speaker assembly 3. The wearing assembly 2 can stably support the speaker assembly 3 at a corresponding position on the human face. The speaker assembly 3 can receive a corresponding signal to generate vibration.

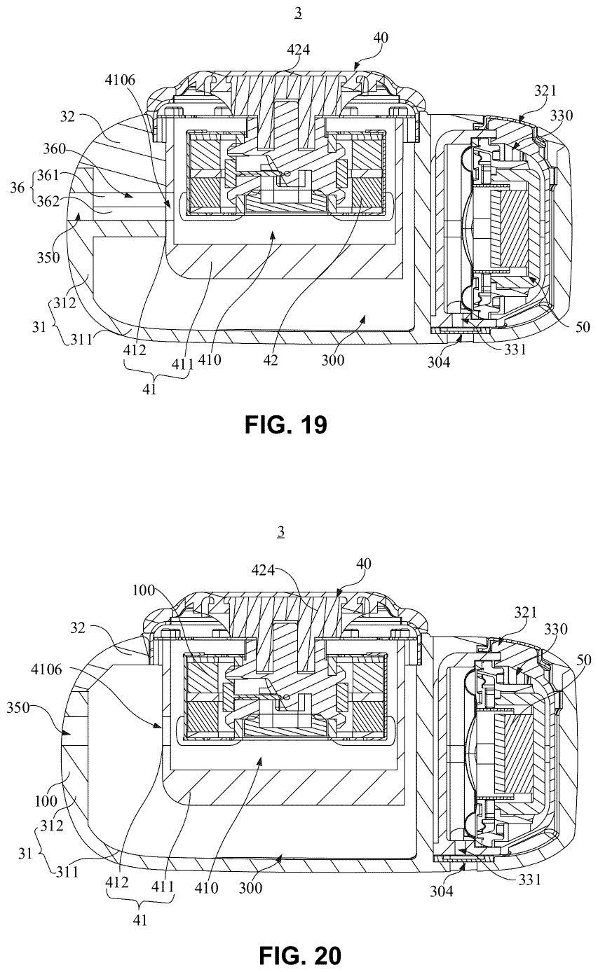

In conjunction with FIG. 19 and FIG. 20, embodiments of the present disclosure provide the speaker assembly 3. The speaker assembly 3 includes the housing assembly 30 and the bone conduction speaker 40.

The housing assembly 30 is disposed with the accommodation space 300. The accommodation space 300 is configured to accommodate the bone conduction speaker 40. The housing assembly 30 provides mechanical support for the bone conduction speaker 40, and is configured to accommodate, for example, the battery, the electronic control board, or the control circuit for driving the bone conduction speaker 40.

The bone conduction speaker 40 includes the core shell 41 and the transducer 42. The core shell 41 is supported on the housing assembly 30 and at least partially disposed in the accommodation space 300. The core shell 41 is disposed with a mounting space 410, and the transducer 42 is disposed within the mounting space 410. A volume of the mounting space 410 is smaller than a volume of the accommodation space 300. The mounting space 410 may be configured to accommodate the transducer 42, and the accommodation space 300 may be configured to accommodate at least a portion of the core shell 41 and other components. Optionally, the accommodation space 300 may also be configured to accommodate the air conduction speaker 50. The transducer 42 may convert electrical energy into vibrations. The bone conduction speaker 40 includes a vibration transmission plate 424 connected to the transducer 42, and at least a portion of the vibration transmission plate 424 protrudes outwardly through an opening to fit the human face. The vibration generated by the transducer 42 can be received by the user through bone conduction by fitting the human face.

Further, in combination with FIG. 19 to FIG. 21, the core shell 41 is disposed with a first sound guiding hole 4106 in flow communication with the mounting space 410, the housing assembly 30 is disposed with a second sound guiding hole 350 in flow communication with the first sound guiding hole 4106, and the first sound guiding hole 4106 is in flow communication with the outside through the second sound guiding hole 350. When the mounting space 410 is in flow communication with the outside world through the first sound guiding hole 4106 and the second sound guiding hole 350, an air pressure change in the mounting space 410 caused by the vibration of the transducer 42 is able to be balanced through the first sound guiding hole 4106 and the second sound guiding hole 350.

In some embodiments, the sound conducted to the outside world by the transducer 42 through the first sound guiding hole 4106 and the second sound guiding hole 350 is in opposite phase to a sound leakage generated by the transducer 42 through the vibration transmission plate 424, and the sound leakage and the sound emitted from the first sound guiding hole 4106 and the second sound guiding hole 350 are at least partially canceled, thereby further improving the sound leakage phenomenon of the speaker assembly 3 and further improving the sound quality of the speaker assembly 3.

Compared to the above-described scheme of the present disclosure, if the transducer 42 is directly mounted in the accommodation space 300 with a relatively great volume, a frequency at which the sound wave generated by the transducer 42 resonates with the cavity formed by the housing assembly 30 is relatively low. In this situation, during the operation of the bone conduction speaker 40, the sound wave generated by the transducer 42 is very likely to resonate with the housing assembly 30, which on the one hand leads to an increase in the sound leakage, and on the other hand leads to a sudden change in the frequency response. As a result, the sound leakage cannot be well canceled. When the resonance frequency is relatively low, an acoustic performance of the bone conduction speaker 40 may not be ensured in a relatively balanced manner. In an embodiment of the present disclosure, by accommodating the transducer 42 in the core shell 41, and using the housing assembly 30 to accommodate the core shell 41 and other portions of the core shell 41, the mounting space 410 with a smaller volume is spaced apart from the accommodation space 300 with a greater volume, and the resonance frequency between the sound wave generated by the transducer 42 and the cavity formed by the core shell 41 with the smaller mounting space 410 is relatively high. In this way, on the one hand, the sound wave generated by the transducer 42 is less likely to resonate with the core shell 41, and on the other hand, the sudden change caused by the resonance of the sound wave generated by the transducer 42 in the lower frequency band is reduced, which is more conducive to the interfering cancellation between the sound leakage generated by the vibration plate 424 and the sound leakage transmitted through the first sound guiding hole 4106, which is conducive to reducing the sound leakage of the speaker assembly 3, thus improving the sound quality of the speaker assembly 3.

Specifically, in some embodiments, in conjunction with FIG. 20, the first sound guiding hole 4106 and the second sound guiding hole 350 are respectively in flow communication with the accommodation space 300 disposed at the periphery of the core shell 41. In other words, the first sound guiding hole 4106 is in flow communication with the second sound guiding hole 350 through the accommodation space 300 at the periphery of the core shell 41. The change in air pressure and the air conduction sound generated by the vibration of the transducer 42 may be conducted from the first sound guiding hole 4106 to the second sound guiding hole 350 through the accommodation space 300, and then to the outside world, thereby reducing the sound leakage of the speaker assembly 3.

Optionally, in some embodiments, the first sound guiding hole 4106 and the second sound guiding hole 350 are disposed opposite to each other in a radial direction of the transducer 42. The transducer 42 has the vibration direction, and the radial direction of the transducer 42 refers to a direction perpendicular to the vibration direction of the transducer 42. That is, the first sound guiding hole 4106 and the second sound guiding hole 350 have a depth direction perpendicular to the vibration direction of the transducer 42.

The vibration of the transducer 42 transmitted from the first sound guiding hole 4106 and the second sound guiding hole 350 are transmitted in the form of air conduction sound waves, and by setting the first sound guiding hole 4106 and the second sound guiding hole 350 opposite to each other in the radial direction of the transducer 42, it facilitates the sound waves in the mounting space 410 to be transmitted from the first sound guiding hole 4106 and the second sound guiding hole 350, which improves the sound wave transmission efficiency, and makes it easier for the first sound guiding hole 4106 and the second sound guiding hole 350 to achieve the aforementioned technical effects, thereby further reducing the sound leakage of the speaker assembly 3.

In some embodiments, there are a plurality of first sound guiding holes 4106 arranged at intervals on the circumferential sidewall 412 of the core shell 41 along a circumferential direction of the core shell 41. In other embodiments, there are a plurality of second sound guiding holes 350 arranged at intervals on the circumferential side wall 312 of the housing assembly 30 along the circumferential direction of the housing assembly 30.

In some other embodiments, there are a plurality of first sound guiding holes 4106 arranged at intervals on the circumferential sidewall 412 of the core shell 41 along the circumferential direction of the core shell 41. There are a plurality of second sound guiding holes 350 arranged at intervals on the circumferential side wall 312 of the housing assembly 30 along the circumferential direction of the housing assembly 30. By disposing the plurality of first sound guiding holes 4106 on the circumferential sidewall 412 of the core shell 41 and/or the plurality of second sound guiding holes 350 on the circumferential sidewall 312 of the housing assembly 30, the sound waves generated by the transducer 42 may be conducted along a plurality of different directions to the outside world, which optimizes the sound leakage reducing effect of the first sound guiding holes 4106 and the second sound guiding holes 350.

In other embodiments, in conjunction with FIG. 19, the housing assembly 30 includes a channel member 36 forming a sound channel 360. The channel member 36 is disposed within the accommodation space 300. The sound channel 360 is in flow communication with the first sound guiding hole 4106 and the second sound guiding hole 350 at two ends of the sound channel 360, respectively, and the mounting space 410 is in flow communication with the outside world through the first sound guiding hole 4106, the sound channel 360, and the second sound guiding hole 350, thereby reducing the sound leakage of the speaker assembly 3.

In some embodiments, by providing independent channel member 36, the sound waves within the mounting space 410 are conducted directly to the outside world without passing through the accommodation space 300, which reduces the interference of the sound waves on the internal parts of the accommodation space 300 as well as reduces a possibility of resonance of the sound waves with the housing assembly 30 after entering the accommodation space 300.

A volume of the sound channel 360 is smaller than the volume of the accommodation space 300 disposed at the periphery of the core shell 41. In this way, the sound wave generated by the transducer 42 has a relatively high resonance frequency with the channel member 36, which reduces the sudden change of the sound wave at the lower frequency band, and is more conducive to the interfering cancellation of far-field sound leakage, so as to reduce the sound leakage.

In summary, by setting the volume of the mounting space 410 to be smaller than the volume of the accommodation space 300 and by setting the volume of the acoustic channel 360 to be smaller than the volume of the accommodation space 300, the acoustic wave generated by the transducer 42 may have a relatively high resonance frequency with the core shell 41 and the channel member 36 during the conduction process, so that the sound waves generated by the transducer 42 are less likely to resonate with the components in the conduction path during the conduction process, thereby reducing the sound leakage caused by resonance.

Optionally, in some embodiments, the volume of the sound channel 360 is smaller than the volume of the mounting space 410, so as to further increase the resonance frequency of the sound waves with the channel member 36, making the channel member 36 less likely to resonate with the sound waves, thereby reducing the sound leakage.

In some embodiments, the housing assembly 30 includes the main housing 31 with an open end, and the main cover body 32 covering the open end 301 of the main housing 31. In this way, when the speaker assembly 3 is assembled, the battery, the electronic control board, the control circuit, and the bone conduction speaker 40 may be assembled with the main housing 31 or the main cover body 32, and then the main cover body 32 may be assembled with the main housing 31, which is simple and is conducive to improving the assembly efficiency. The core shell 41 is supported on the main housing 31 or the main cover body 32. Optionally, the core shell 41 may be integrally molded with the main cover body 32 or the main housing 31. The main cover body 32 is disposed with an opening in flow communication with the accommodation space 300, and at least a portion of the bone conduction speaker 40 may pass through the opening disposed on the main cover body 32 to fit the face. At least a portion of the channel member 36 is disposed on the main cover body 32, and the main cover body 32 may be configured to mount the channel member 36 or be integrally molded with the at least a portion of the channel member 36.

In some embodiments, in conjunction with FIG. 19, the channel member 36 includes a first channel portion 361 and a second channel portion 362, with the first channel portion 361 being disposed on the main cover body 32 and the second channel portion 362 being disposed on the main housing 31. When the main cover body 32 and the main housing 31 are assembled, the first channel portion 361 and the second channel portion 362 cooperate with each other to form the sound channel 360. For example, the first channel portion 361 is a through slot disposed on the main cover body 32, and the second channel portion 362 is a through slot disposed on the main housing 31, and the two channel portions are spliced with each other to form a complete sound channel 360 when the main cover body 32 and the main housing 31 are assembled. The first channel portion 361 and the second channel portion 362 may be a first channel member 36 and a second channel member 36 mounted on the main cover body 32 and the main housing 31, respectively, or may be a first through slot and a second through slot machined or injection molded on the main cover body 32 and the main housing 31, which is not specifically limited herein. Through the above-described manner, the assembly of the channel member 36 may be simplified, so that the process of forming the sound channel 360 is integrated into the assembly process of the main cover body 32 and the main housing 31, which is conducive to improving the assembly efficiency of the speaker assembly 3.

In some embodiments, in conjunction with FIG. 19 and FIG. 20, the speaker assembly 3 includes the air conduction speaker 50 disposed in the accommodation space 300. The air conduction speaker 50 is disposed with the first sound outlet 330, and the air conduction speaker 50 emits sound outwardly through the first sound outlet 330. The housing assembly 30 is disposed with the second sound outlet 321 in flow communication with the accommodation space 300, and the sound waves generated by the air conduction speaker 50 may be transmitted to the outside world through the second sound outlet 321, and then entered the human ear through air conduction. The first sound outlet 330 and the second sound guiding hole 350 are disposed at intervals, so as to reduce a mutual interaction between the sound generated by the bone conduction speaker 40 through the second guiding hole 350 and the sound generated by the air conduction speaker 50, which improves an acoustic performance of the speaker assembly 3. Specifically, the housing assembly 30 is disposed with an opening in flow communication with the accommodation space 300, the bone conduction speaker 40 includes the vibration transmission plate 424 connected to the transducer 42, and at least a portion of the vibration transmission plate 424 protrudes outwardly through the opening to fit the human face. When viewed in the vibration direction of the vibration plate 424, the second sound outlet 321 is located between the vibration plate 424 and the tragus. In this way, a sound output position of the air conduction speaker 50 is closer to the ear canal, and the sound waves generated by the air conduction speaker 50 may enter the ear canal at a closer distance, which reduces a loss of the sound waves in a propagation process and further improves the acoustic performance of the speaker assembly 3.

In some embodiments, specifically, the housing assembly 30 further includes the main housing 31 and the main cover body 32. The main cover body 32 covers on the open end of the main housing 31, and the second sound outlet 321 is disposed on the main cover body 32. In this way, in the assembly process, the battery, the electronic control board, the control circuit, the air conduction speaker 50, and the bone conduction speaker 40 may be assembled with the main housing 31 or the main cover body 32, and then the main cover body 32 is assembled with the main housing 31, which is simple and is conducive to improving the assembly efficiency.

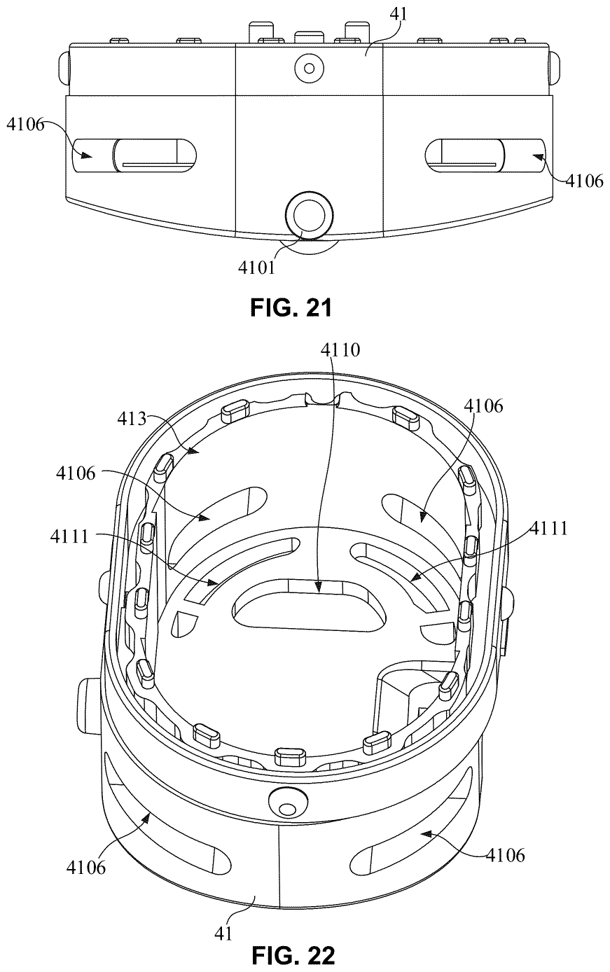

In conjunction with FIG. 21 to FIG. 23, the core shell 41 is supported on the main housing 31 or the main cover body 32. Optionally, the core shell 41 may be integrally molded with the main cover body 32 or the main housing 31. The main cover body 32 is disposed with the opening in flow communication with the accommodation space 300, and the core shell 41 and the vibration transmission plate 424 are at least partially exposed through the opening and pass through the opening disposed on the main cover body 32 to fit the face. The main housing 31 includes the bottom wall 311 and the circumferential sidewall 312 connected to the bottom wall 311 to form the accommodation space 300 having the opening end. The second sound guiding hole 350 is disposed on the circumferential sidewall 312, and the sound waves derived from the first sound guiding hole 4106 may be conducted to the outside world through the circumferential sidewall 312 of the main housing 31. By disposing the second sound outlet 321 for the air conduction speaker 50 to emit sound and the opening for the bone conduction speaker 40 to emit sound on the main cover body 32, both the vibration of the bone conduction speaker 40 and the vibration of the air conduction speaker 50 may be received by the user on one side of the main cover body 32 through fitting the human face and air conduction, respectively, which enables the speaker assembly 3 of the present disclosure to have a good acoustic performance.

In some embodiments, the air conduction speaker 50 is inserted into the accommodation space 300 from the open end 301 of the main housing 31, and the air conduction speaker 50 is further disposed with the first pressure relief hole 331. The second pressure relief hole 304 is disposed corresponding to the first pressure relief hole 331 on the bottom wall 311. The air conduction speaker 50, in the process of generating the sound waves, causes a change in the air pressure inside the air conduction speaker 50, and by providing the first pressure relief hole 331, the air pressure inside the air conduction speaker 50 may be balanced when the sound is generated. The first pressure relief hole 331 is in flow communication with the outside world through the second pressure relief hole 304, so that the air from the outside world may enter the air conduction speaker 50 through the second pressure relief hole 304 and the first pressure relief hole 331. The first pressure relief hole 331 is in flow communication with the second pressure relief hole 304 through the housing assembly 30, or through the connection member disposed in the accommodation space 300, which is not specifically limited herein.

Further, the first sound outlet 330 and the first pressure relief hole 331 are disposed opposite to each other along the insertion direction of the air conduction speaker 50 relative to the main housing 31. In this way, the direction in which the air conduction speaker 50 emits sound is opposite to the direction in which the first pressure relief hole 331 emits sound, so as to minimize the effect of the sound leakage from the first pressure relief hole 331 on the sound emitted by the first sound outlet 330, thereby improving the acoustic performance of the speaker assembly 3.

In some embodiments, the core shell 41 is rotatably supported on the housing assembly 30 and is capable of rotating relative to the housing assembly 30 along a preset rotation axis. In this way, when the earphone 1 is in the wearing state and the bone conduction speaker 40 is fitted to the user's face, the core shell 41 may rotate relative to the vibration transmission plate 424 under the cooperation between a pressure of the wearing member and a support force of the user's face on the bone conduction speaker 40, so that the vibration transmission plate 424 can further fit the human face, the pressure between the vibration transmission plate 424 and the face is more uniform, and the bone conduction speaker 40 has a better sound transmission effect. The vibration direction of the air conduction speaker 50 is parallel to the rotation axis, and the vibration direction of the bone conduction speaker 40 is perpendicular to the rotation axis. In this way, when the bone conduction speaker 40 rotates, as the vibration direction of the bone conduction speaker 40 is perpendicular to the rotation axis, the vibration direction of the bone conduction speaker 40 is always perpendicular to the vibration direction of the air conduction speaker 50. In this way, an influence of the vibration of the bone conduction speaker 40 on the vibration of the air conduction speaker 50 is reduced, so that the vibrations of the two are relatively more independent, thereby improving the acoustic performance of the speaker assembly 3.

In conjunction with FIG. 24, embodiments of the present disclosure provide the speaker assembly 3. The speaker assembly 3 includes the housing assembly 30, the bone conduction speaker 40, and the air conduction speaker 50. The housing assembly 30 includes the main housing 31, and the main housing 31 forms the accommodation space 300 with an open end. The accommodation space 300 may be configured to accommodate the bone conduction speaker 40 and the air conduction speaker 50. The housing assembly 30 may provide mechanical support for the bone conduction speaker 40, and the accommodation space 300 may also be used to accommodate components, for example, the battery, the electronic control board, or the control circuit, that are used to drive the bone conduction speaker 40 to operate. The bone conduction speaker 40 includes the core shell 41 and the transducer 42. The core shell 41 is rotatably supported on the main housing 31 and is partially disposed within the accommodation space 300. When the earphone 1 is in the wearing state and the bone conduction speakers 40 fits the user's face, the core shell 41 can rotate under the cooperation of the pressure of the wearing member and the support force of the face on the bone conduction speaker 40, which makes the vibration plate 424 of the bone conduction speaker 40 further fit the human face, so that the pressure between the vibrating plate 424 and the human face is more uniform, and the bone conduction speaker 40 has a better sound transmission effect.

In some embodiments, the core shell 41 is provided with the mounting space 410, and the volume of the mounting space 410 is smaller than the volume of the accommodation space 300. The transducer 42 is disposed within the mounting space 410. If the transducer 42 is directly mounted in the accommodation space 300 with a greater volume, the frequency at which the sound wave generated by the transducer 42 resonates with the housing assembly 30 is relatively low such that when the bone conduction speaker 40 is operating, the sound wave generated by the transducer 42 is very likely to resonate with the housing assembly 30, which on the one hand leads to an increase in the sound leakage, and on the other hand leads to the sudden change in the frequency response of the sound wave, resulting in that the sound leakage cannot be interfered and canceled. When the resonance frequency is relatively low, the acoustic performance of the bone conduction speaker 40 may not be balanced. In an embodiment of the present disclosure, the transducer 42 is accommodated by the core shell 41, and the housing assembly 30 is configured to accommodate the core shell 41 and other components. In this way, the mounting space 410 with a smaller volume is spaced apart from the accommodation space 300 with a greater volume by the core shell 41. The resonance frequency of the sound wave generated by the transducer 42 and a cavity formed by the core shell 41 with the smaller mounting space 410 is relatively high. In this way, on the one hand, the sound wave generated by the transducer 42 is less likely to resonate with the core shell 41, and on the other hand, the sudden change of the sound wave generated by the transducer 42 in a lower frequency band due to resonance is reduced, which is more conducive to the interfering cancellation of the sound leakages between the vibration plate 424 and the sound guiding hole 4106 (also referred to as a first sound guiding hole), and the reduction of the sound leakage of the speaker assembly 3, thus improving the sound quality effect of the speaker assembly 3.

In some embodiments, in conjunction with FIG. 21 to FIG. 24, the core shell 41 is provided with the sound guiding hole 4106 in flow communication with the mounting space 410. The mounting space 410 is in flow communication with the outside word through the sound guiding hole 4106, and the pressure change caused by the vibration of the transducer 42 in the mounting space 410 may be balanced through the sound guiding hole 4106. In some embodiments, the sound conducted by the transducer 42 through the sound guiding hole 4106 to the outside world is in opposite phase to the sound leakage generated by the transducer 42, and the sound leakage and the sound emitted from the sound guiding hole 4106 can cancel each other, thus reducing the sound leakage of the speaker assembly 3.

In some embodiments, the sound guiding hole 4106 remains exposed relative to the open end of the main housing 31 when the speaker assembly 3 is in the wearing state. Optionally, the sound guiding hole 4106 may be partially exposed relative to the open end of the main housing 31, i.e., the sound guiding hole 4106 may be partially in direct communication with the outside world, and partially in communication with the accommodation space 300 or the opening of the main housing 31. Optionally, the sound guiding hole 4106 may be fully exposed relative to the open end of the main housing 31, i.e., the sound guiding hole 4106 is in direct communication with the outside world without passing through the accommodation space 300. Specifically, the core shell 41 includes the bottom shell wall 411 and the circumferential sidewall 412 connected to the bottom shell wall 411 to form the mounting space 410. A portion of the circumferential sidewall 412 and the bottom shell wall 411 are disposed within the accommodation space 300, and the circumferential sidewall 412 further includes a portion that is exposed relative to the main housing 31 through the open end 301 in the wearing state. The sound guiding hole 4106 is disposed in a portion or all of the exposed portion of the circumferential sidewall 412. In other words, the sound guiding hole 4106 disposed on the core shell 41 is in direct communication with the outside world without passing through the accommodation space 300. In other words, the sound guiding hole 4106 directly conducts sound waves in the mounting space 410 to the outside world without passing through the accommodation space 300, which reduces the interference of the sound waves on the internal components of the accommodation space 30 and reduces the resonance of the sound waves with the housing assembly 30 after entering the accommodation space 300, which is conducive to reducing the sound leakage of the speaker assembly 3. In some embodiments, a ratio of an extended length of the acoustic sound guiding hole 4106 to a width is in a range of 3-8, such as in a range of 5-7, for example, 5.5, 6, or 6.5. The sound guiding hole 4106 having a suitable extension length and width enables the sound waves to be transmitted more conveniently, and enables the sound waves to have a suitable resonance frequency at the sound guiding hole 4106, which is conducive to improving the acoustic performance of the speaker assembly 3.

In some embodiments, the main housing 31 is disposed with the first shaft mechanism 3111 and the second shaft mechanism 3112 that are opposite to each other. The circumferential sidewall 412 is disposed with the third shaft mechanism 4101 and the fourth shaft mechanism 4102 on opposite sides, respectively, and the third shaft mechanism 4101 and the fourth shaft mechanism 4102 extend along a preset axis. The first shaft mechanism 3111 cooperates with the third shaft mechanism 4101, and the second shaft mechanism 3112 cooperates with the fourth shaft mechanism 4102, thereby rotatably supporting the core shell 41 on the main housing 31. The first shaft mechanism 3111 and the third shaft mechanism 4101 form a rotational pair, and the second shaft mechanism 3112 and the fourth shaft mechanism 4102 form a rotational pair. Taking the first shaft mechanism 3111 and the third shaft mechanism 4101 as an example, the rotational pair may be constituted by forming a hole-like or slot-like first shaft mechanism 3111 on the main housing 31 and a shaft-shaped third shaft mechanism 4101 on the circumferential sidewall 412, and the third shaft mechanism 4101 is inserted into the first shaft mechanism 3111 to form the rotational pair. Alternatively, the hole-like or slot-like third shaft mechanism 4101 is formed on the circumferential sidewall 412, the shaft-shaped first shaft mechanism 3111 is formed on the main housing 31, and the first shaft mechanism 3111 is inserted into the first shaft mechanism 4101 to form the rotational pair. The cooperation between the first shaft mechanism 3111 and the third shaft mechanism 4101 may also be realized by a mechanism such as a bearing, a damper, or a ratchet, etc. The second shaft mechanism 3112 and the fourth shaft mechanism 4102 are the same, which is not repeated.

In some embodiments, the vibration direction of the transducer 42 has an outwardly pointing direction pointing to the outside of the accommodation space 300, and in the outwardly pointing direction, the sound guiding hole 4106 is located above the third shaft mechanism 4101 and the fourth shaft mechanism 4102. By disposing the sound guiding hole 4106 above the third shaft mechanism 4101 and the fourth shaft mechanism 4102, an obstruction of the sound guiding hole 4106 by the third shaft mechanism 4101 and the fourth shaft mechanism 4102 may be reduced. When the core shell 41 rotates relative to the main housing 31, the sound guiding hole 4106 is kept exposed, so that the sound waves conducted by the sound guiding hole 4106 is directly conducted to the outside world.

In some embodiments, there are four sound guiding holes 4106 disposed on opposing sides of the circumferential sidewalls 412 two by two, respectively. By disposing a plurality of sound guiding holes 4106 on the circumferential sidewall 412 of the core shell 41, the sound waves generated by the transducer 42 may be conducted to the outside world along a plurality of different directions, thereby optimizing the sound leakage reduction effect of the sound guiding hole 4106. The third shaft mechanism 4101 or the fourth shaft mechanism 4102 is disposed between two sound guiding holes 4106 on the same side in the circumferential direction. In other words, the sound guiding hole 4106 and the third shaft mechanism 4101 or the fourth shaft mechanism 4102 are staggered on the core shell 41, so that the sound from the sound guiding hole 4106 and the rotations of the third shaft mechanism 4101 and the fourth shaft mechanism 4102 do not interfere with each other to improve reliability of the use of the speaker assembly 3.

In some embodiments, the main housing 31 includes the bottom wall 311 and the circumferential sidewall 312 connected to the bottom wall 311 to form the accommodation space 300. The bone conduction speaker 40 includes the vibration transmission plate 424 and the first vibration transmission sheet 45. The transducer 42 includes the bracket 421. The bracket 421 can be wound by a coil and support and maintain a shape of the coil. When the transducer 42 operates, the coil can drive the bracket 421 to vibrate under an action of electric current and magnetic field. The first vibration transmission sheet 45 connects the bracket 421 and the core shell 41 to elastically suspend the transducer 42 within the mounting space 410. During the vibration of the bracket 421, the first vibration transmission sheet 45 can attenuate the vibration transmitted from the bracket 421 to the core shell 41 to minimize the sound leakage. The bracket 421 is connected with the vibration transmission plate 424 along a spacing direction between the bracket 421 and the bottom wall 311, and the vibration of the bracket 421 drives the vibration transmission plate 424 to vibrate, and the vibration transmission plate 424 transmits the vibration to the human face.

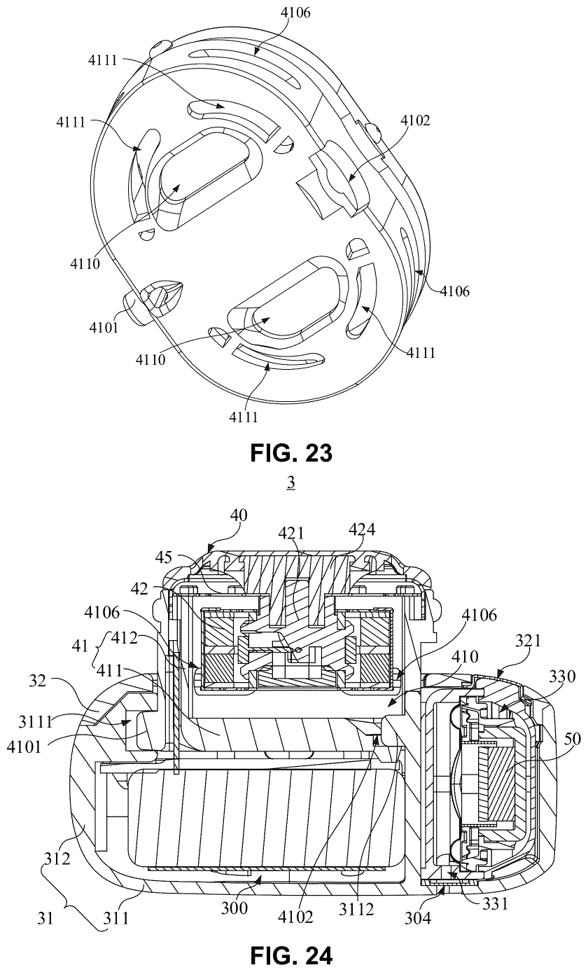

Further, in combination with FIG. 22 and FIG. 23, the bottom shell wall 411 is disposed with the through hole 4110 opposite to the bracket 421, the mounting space 410 is in flow communication with the accommodation space 300 through the through hole 4110, the through hole 4110 is configured to allow a support fixture to be inserted into the mounting space 410 through the through hole 4110 and support the bracket 421 when the bracket 421 is located in the mounting space 410. The transducer 42 of the present disclosure is suspended in the mounting space 410 through the first vibration transmission sheet 45. In the assembly process, to reduce the deformation of the first vibration transducer 45, the first the transducer 42 is first placed in the mounting space 410, and then the first vibration transducer 45 is connected to the bracket 421 and the core shell 41, respectively. The transducer 42 requires additional fixture support to enable the transducer 42 to be located in a desired assembly position before the first vibration transmission sheet 45 is installed. By disposing the through hole 4110 in the bottom shell wall 411 to insert the support fixture, the bracket 421 is supported when the first vibration transmission sheet 45 is not mounted, so as to support the transducer 42 to be located in the desired position. The first vibration transmission sheet 45 is then connected to the bracket 421 and the core shell 41. The first vibration transducer 45, after being connected to the bracket 421 and the core shell 41, can elastically suspend the transducer 42 within the mounting space 410, and the fixture may then be withdrawn through the through hole 4110. The assembly of the transducer 42 and the first vibration transducer 45 may be facilitated in the above-described manner, which improves the success rate of the assembly. On the other hand, the mounting space 410 is in flow communication with the accommodation space 300 or the outside world through the through hole 4110, which can further assist the sound guiding hole 4106 to emit sound and reduce the sound leakage.

In some embodiments, the bone conduction speaker 40 has a long-axis direction and a short-axis direction when viewed in the vibration direction of the transducer 42, and the bone conduction speaker 40 has a greater size along the long-axis direction than along the short-axis direction. In this way, it facilitates an adaptation of the bone conduction speaker 40 to the human face, and increases an area of the vibration transmission region while presenting the volume of the bone conduction speaker 40 from being too great, thereby improving the wearing comfort. Furthermore, there are two through holes 4110 spaced apart along the long-axis direction. The two through holes 4110 are spaced apart in the long axis direction, which facilitates the simultaneous insertion of fixtures, and the fixtures may jointly support the bracket 421 to further improve the success rate of assembly.

In some embodiments, in conjunction with FIG. 22 and FIG. 23, the bottom shell wall 411 is further disposed with mounting hole 4111 adjacent to an inner wall surface of the circumferential sidewall 412. The mounting hole 4111 is spaced apart from the through hole 4110. The mounting space 410 is in flow communication with the accommodation space 300 through the mounting hole 4111. The mounting hole 4111 is configured to allow a sound resistance net to be inserted into the mounting space 410 from the mounting hole 4111 to fit against the inner wall surface of the circumferential sidewall 412 and cover the sound guiding hole 4106. In other embodiments, the bottom shell wall 411 is not disposed with the mounting hole 4111, and the sound resistance net enters the core shell 41 from the open end 413 of the core shell 41, and then is mounted and covered on the sound guiding hole 4106. As the sound guiding hole 4106 is directly communication with the outside world, particles of dust, etc. from the outside world can enter the mounting space 410 through the sound guiding hole 4106 to affect the operation of the transducer 42. The sound resistance net allows the sound to pass through and acts as a barrier to particulate dust etc., and also acts to regulate acoustic effects. By disposing the sound resistance net to cover the sound guiding hole 4106 in the mounting space 410, a disturbance of the outside particulate dust to the mounting space 410 may be reduced, and the reliability of the operation of the speaker assembly 3 may be improved. On the other hand, the mounting space 410 is in flow communication with the accommodation space 300 or the outside world through the mounting hole 4111, which also helps reduce the sound leakage. Further, the mounting hole 4111 is disposed in correspondence with the sound guiding hole 4106. The mounting hole 4111 and the corresponding sound guiding hole 4106 are proximate to each other on two sides of a connecting edge between the bottom shell wall 411 and the circumferential sidewall 412. In this way, the installation of the sound resistance net is facilitated, and the success rate of the assembly is improved. The sound resistance net may, for example, include at least one of stencil and a mesh.

In some embodiments, a distance between the mounting hole 4111 and the corresponding sound guiding hole 4106 in the vibration direction of the bone conduction speaker 40 may be from 1.5 to 5.5 mm, for example, 2 mm, 2.9 mm, 3.1 mm, 3.3 mm, 3.5 mm, or 4 mm. The suitable distance between the mounting hole 4111 and the sound conduction hole 4106, on the one hand, can facilitate assembly, and on the other hand, can avoid a situation where a too-close distance between the mounting holes 4111 and the sound conduction holes 4106 leads to an insufficient rigidity of the portion of the corresponding core shell 41.

The above is only an example of the present disclosure, and is not intended to limit the scope thereof. Any equivalent structure or equivalent process transformations utilizing the contents of the present disclosure and the accompanying drawings, or directly or indirectly applying them in other related technical fields, are included in the protection scope of the present disclosure.

What is claimed is:

1. A speaker assembly comprising:
a housing assembly including a main housing;
an air conduction speaker disposed within the main housing; and
a bone conduction speaker rotatably supported on the main housing and being capable of rotating relative to the main housing along a preset rotation axis, wherein
a vibration direction of the air conduction speaker is parallel to the preset rotation axis, and a vibration direction of the bone conduction speaker is perpendicular to the preset rotation axis.

2. The speaker assembly of claim 1, wherein
the main housing includes a first bottom wall and a first circumferential sidewall connected to the first bottom wall to form a first accommodation space with an open end,
the air conduction speaker and the bone conduction speaker are disposed within the first accommodation space from the open end of the main housing,
a vibration direction of the air conduction speaker is toward or away from the first circumferential sidewall, and
a vibration direction of the bone conduction speaker is toward or away from the first bottom wall.

3. The speaker assembly of claim 2, wherein each of the main housing and a core shell is provided with a shaft mechanism that is mounted in a detachable manner, and the core shell is rotatably supported on the main housing through the shaft mechanisms of the main housing and the core shell.

4. The speaker assembly of claim 2, wherein the first circumferential sidewall includes a first sidewall and a second sidewall disposed opposite to each other,
the main housing further includes a partition assembly disposed between the first sidewall and the second sidewall and at least partially spaced apart from the first sidewall and the second sidewall, respectively,
the partition assembly and the second sidewall are provided with a first shaft mechanism and a second shaft mechanism, respectively.

5. The speaker assembly of claim 4, wherein the core shell is disposed between the partition assembly and the second sidewall,
a third shaft mechanism and a fourth shaft mechanism are respectively disposed on opposite sides of the core shell,
the first shaft mechanism rotatably cooperates with the third shaft mechanism, and the second shaft mechanism rotatably cooperates with the fourth shaft mechanism, thereby rotatably supporting the core shell on the main housing.

6. The speaker assembly of claim 4, wherein
the partition assembly is configured to elastically deform in a spacing direction between the first sidewall and the second sidewall when the core shell is assembled to the main housing, and
an elastic deformation capacity of the partition assembly along the spacing direction between the first sidewall and the second sidewall is greater than an elastic deformation capacity of the first sidewall and the second sidewall along the spacing direction between the first sidewall and the second sidewall.

7. The speaker assembly of claim 4, wherein the air conduction speaker is disposed between the partition assembly and the first sidewall.

8. The speaker assembly of claim 4, wherein the housing assembly further includes a main cover body covering the open end of the main housing,
the air conduction speaker is disposed with a first sound outlet,
the first sound outlet is disposed facing the main cover body, and
the main cover body is disposed with a second sound outlet corresponding to the first sound outlet.

9. The speaker assembly of claim 8, wherein the bone conduction speaker includes a transducer and a vibration plate, the transducer is disposed in the core shell, and the vibration plate is connected to the transducer.

10. The speaker assembly of claim 9, wherein the first shaft mechanism and the second shaft mechanism are protruded outside the open end of the main housing, the main cover body is disposed with an opening, and the core shell and the vibration plate are exposed through the opening of the main cover body.

11. The speaker assembly of claim 9, wherein in a wearing state, the vibration plate is in direct or indirect contact with a face region on a front side of a tragus of a user, and when viewed in a vibration direction of the vibration plate, the second sound outlet is disposed between the vibration plate and the tragus.

12. The speaker assembly of claim 11, wherein in the wearing state, the second sound outlet is disposed facing the human ear.

13. The speaker assembly of claim 3, wherein the bone conduction speaker further includes a lead, the core shell is disposed with a housing lead hole, and the lead extends into the core shell through the housing lead wire hole and is electrically connected to a transducer of the bone conduction speaker.

14. The speaker assembly of claim 13, wherein an extension direction of the housing lead hole intersects the preset rotation axis.

15. The speaker assembly of claim 13, wherein the speaker assembly further includes a control circuit board disposed between the first bottom wall and the core shell, and the lead connects the control circuit board.

16. The speaker assembly of claim 3, wherein the core shell includes a second bottom wall and a second circumferential sidewall connected to the second bottom wall to form a second accommodating space with an open end, and a transducer of the bone conduction speaker is disposed in the second accommodation space.

17. The speaker assembly of claim 16, wherein the second bottom wall is disposed facing the first bottom wall relative to the open end of the core shell, the housing lead hole is disposed in the second bottom wall, the shaft mechanism on the core shell is disposed on the second circumferential sidewall.

18. The speaker assembly of claim 16, wherein the bone conduction speaker includes a vibration plate,
in a vibration direction of the vibration plate, a distance between the shaft mechanism of the core shell and the second bottom wall is less than a distance between the shaft mechanism of the core shell and the open end of the second accommodating space.

19. The speaker assembly of claim 16, wherein the shaft mechanism and the second bottom wall are arranged on the same plane.

20. An earphone comprising the speaker assembly of claim 1 and a wearing assembly connected to the speaker assembly, the wearing assembly being configured to position the speaker assembly in a face region on a front side of a tragus of a user when the earphone is in a wearing state.
